(19) United States
(12) Patent Application Publication
(10) Pub. No.: US 2002/0057059 A1
(43) Pub. Date: May 16, 2002

(54) Fluorescent lamp, self-ballasted fluorescent lamp and lighting apparatus

(76) Inventors: Kazuhisa Ogishi, Kanagawa-ken (JP); Hidenori Ito, Kanagawa-ken (JP); Seiko Kawashima, Kanagawa-ken (JP); Nobuhiro Tamura, Kanagawa-ken (JP); Yuichi Sakakibara, Kanagawa-ken (JP); Keiji Hatakeyama, Kanagawa-ken (JP)

Correspondence Address: PILLSBURY WINTHROP LLP, 1600 TYSONS BOULEVARD, MCLEAN, VA, 22102, US

(21) Appl. No.: 09/916,206

(22) Filed: Jul. 27, 2001

(30) Foreign Application Priority Data
Jul. 28, 2000 (JP) P2000-229744
Aug. 31, 2000 (JP) P2000-268433
Dec. 28, 2000 (JP) P2000-402826
Apr. 27, 2001 (JP) P2001-132632

(51) Int. Cl. H01J 17/16

(52) U.S. Cl. 313/636

(57) ABSTRACT

The fluorescent lamp has a bulb formed by lead-free glass having an ultraviolet ray transmission factor of 40% or less at 300 nm or less, mercury gas and rare gas sealed in the glass bulb, a phosphor layer formed on the inner wall of the glass bulb, and a pair of discharge electrodes for causing discharge in the glass bulb and the lead-free glass contains an ultraviolet ray reduction material for absorbing or reflecting ultraviolet rays generated from the fluorescent lamp and can reduce ultraviolet rays to 40% or less at a wavelength of 300 nm or less.

### FIELD OF THE INVENTION

The present invention relates to a fluorescent lamp using lead-free glass containing lead-free component practically, a self-ballasted fluorescent lamp, and a lighting apparatus.

### BACKGROUND OF THE INVENTION

A self-ballasted fluorescent lamp mountable to a socket of a lighting fixture for an incandescent lamp as it is in wide use as a substitute light source of an incandescent lamp. The external size thereof is miniaturized on the nearly same size as an incandescent lamp as described in, for example, Japanese Patent No. 3132562.

In such a self-ballasted fluorescent lamp, the bulb is bent almost in a U-shape to minimize the external size. To facilitate the bending process, lead glass with a low softening temperature is conventionally used to form a bulb. Namely, lead oxide has an effect for lowering the softening point of glass and improving the workability.

However, from the viewpoint of a problem that lead is an injurious material and environmental pollution is caused by waste of a used fluorescent lamp, it is desirable to reduce the use amount of lead inasmuch as is possible. Therefore, it has been desired in recent years to form a bulb by lead-free glass (or less-lead glass) containing substantially no lead and having a lower softening temperature.

Further, soda-lime glass containing considerably much sodium oxide is glass containing lead-free component practically and having a low softening temperature, so that it is widely used as a glass bulb of a fluorescent lamp.

However, soda-lime glass generally contains sodium oxide of 15 to 17 weight percent (hereinafter abbreviated as wt-%), so that it has a property that sodium ions show tendency to be educed on the inner wall of a glass bulb within a period of lamp life time. The educed sodium ions and mercury vapor sealed in the glass bulb react with each other and the inner wall of the glass bulb is colored in blackish brown (so-called ultraviolet ray solarization). The coloring phenomenon causes a problem of reduction in the visible light transmission factor of the glass bulb. Therefore, a fluorescent lamp using lead-free glass that the content of sodium component in glass is reduced for a glass bulb has been studied.

For example, in Japanese Patent Application Laid-Open 2000-315477, Japanese Patent Application Laid-Open 2001-31442, and U.S. Pat. No. 5,470,805, a fluorescent lamp formed by lead-free glass containing sodium oxide of 11% or less is disclosed.

However, it is experimentally found that in a fluorescent lamp with a bulb formed by lead-free glass, compared with a case that a bulb is formed by lead glass, the ultraviolet ray transmission factor of the bulb is increased, so that it is found that there are various problems imposed.

For example, in a fluorescent lamp whose bulb is formed by lead-free glass, residues of ultraviolet rays generated by discharge and not absorbed by the phosphor layer and the bulb, transmit the bulb. Thus the residual ultraviolet rays are irradiated onto an article to be irradiated neighboring to the bulb. No-lead glass transmits comparatively much ultraviolet rays with a wavelength of 300 nm or less, so that effects by ultraviolet rays cannot be ignored.

Particularly, a clarifying process of ejecting fine air bubbles in glass is performed in the glass manufacturing process, though there is a disadvantage that the content of iron oxide (FeO) having an effect of absorbing ultraviolet rays is reduced in correspondence with the clarifying process. Therefore, there is a problem imposed that radiation of ultraviolet rays generated from the inside of the glass bulb cannot be suppressed effectively by the glass bulb.

For example, in a self-ballasted fluorescent lamp that a synthetic resin cover is installed in the neighborhood of the bulb, a problem arises that the resin is deteriorated by irradiation of ultraviolet rays and also the cover temperature is increased more than 100° C. when the lamp is lit and the deterioration of resin is advanced suddenly by the synergistic effect with ultraviolet rays.

Further, a self-ballasted fluorescent lamp and a compact fluorescent lamp may be lit at a high tube wall load.

When the tube wall load is increased, the intensity of radiated ultraviolet rays is increased, so that the amount of ultraviolet rays transmitting lead-free glass is increased. Particularly, it is experimentally ascertained that when the tube wall load is 0.05 W/cm² or more, the amount of ultraviolet rays transmitting lead-free glass containing sodium oxide of 11 wt-% or less cannot be ignored. Here, the tube wall load bw (W/cm²) is defined by the following equation (1).

bw=W1/(π·Le) (1)

where W1 indicates lamp power (W), d an inner diameter (cm) of glass bulb, and Le a discharge path length between both of pair electrodes (cm).

### SUMMARY OF THE INVENTION

The present invention was developed with the aforementioned conventional problems in view and is intended to provide a fluorescent lamp for suppressing the ultraviolet ray radiation amount of a bulb formed by lead-free glass.

Further, the present invention is intended to provide a fluorescent lamp for reducing the sodium component educed on the inner wall of a bulb formed by lead-free glass and preventing the all flux of light from reduction.

A fluorescent lamp having the constitution of an embodiment of the present invention is characterized in that it has a glass bulb containing lead-free component practically, containing sodium oxide of 11 wt-% or less, and having an ultraviolet ray transmission factor of 40% or less at a wavelength of 300 nm or less, mercury and rare gas sealed in the glass bulb, a pair of discharge electrodes for causing discharge in the glass bulb, and a phosphor layer formed on the inner wall of the glass bulb and lights when the tube wall load is 0.05 W/cm² or more.

A fluorescent lamp is a discharge lamp for executing a low pressure mercury vapor discharge. Ultraviolet rays with a wavelength of 254 nm are mainly radiated from excitation mercury atoms by low pressure mercury vapor discharge, so that the ultraviolet rays are radiated onto the phosphor layer and the layer is excited, thus the ultraviolet rays are converted in wavelength and used as visible light or infrared rays.

The ultraviolet ray transmission factor means a one in a state that no phosphor is coated on a bulb and is defined by measurement with a glass piece having the same thickness as that of a bulb. When an ultraviolet ray reduction material is formed on the inner surface or outer surface of a glass bulb in layers, the transmission factor is defined by measurement in a state including the concerned layers.

A bulb is sealed, for example, by using terminal sealing parts at both ends or directly sealed without using them. When a bulb is sealed by using terminal sealing parts, the parts are generally composed of a stem. When a stem is used, a known step structure such as the flare step, bead stem, or button stem can be adopted. When a bulb is directly sealed, the pinch seal can be adopted.

A bulb may be formed in various shapes such that 2 to 4 linear tube shape, ring-shape, U-shape, semicircular-shape, and U-shaped parts are connected in series and properly arranged. For example, in a fluorescent lamp only for high frequency lighting, a bulb having a shape such as a linear tube shape, circular ring-shape, or double circular ring-shape can be used. Further, in a compact fluorescent lamp, a bulb having a shape such as a U (or H)-shape, M (or W)-shape, double U-shape, triple U-shape, or quartet U-shape can be used. When a U-shaped bulb is used, one bent part (or connected part) and two linear parts on both sides thereof are formed. The bent part of a U-shaped bulb may be molded so as to have a not only semicircular but also linear square corner. In the case of triple U-shape, arrangement that three U-shaped unit bulbs are arranged in an almost triangle or arrangement that three U-shaped unit bulbs are overlaid before and behind is available. Furthermore, in the case of quartet U-shape, arrangement that four U-shaped unit bulbs are arranged in a ring-shape or overlaid before and behind is available.

The tube diameter and length (discharge path length) of a bulb are not limited when the tube wall load is 0.05 W/cm² or more. However, generally, the tube diameter of a bulb is 40 mm or less and the tube length is 2400 mm or less. Generally, amalgam for feeding mercury vapor is used for a fluorescent lamp having a relatively large tube wall load. For example, in a fluorescent lamp only for high frequency lighting, the tube diameter is 15 to 25.5 mm and the length along the tube axis is 500 to 2400 mm. In a compact fluorescent lamp, the tube diameter is 25 mm or less, for example, 12 to 24 mm and the length along the tube axis is 2400 mm or less, for example, 200 to 2300 mm. Furthermore, in a self-ballasted fluorescent lamp, the tube diameter is 13 mm or less, for example, 8 to 13 mm and the length along the tube axis is 500 mm or less, for example, 400 to 500 mm. In a fluorescent lamp mainly used for a cold cathode conventionally such as for a liquid crystal back light and a car, a bulb with a tube diameter of 10 mm to 1 mm is mainly used.

Further, the ultraviolet ray transmission factor of the aforementioned bulbs is preferably 40% or less at 300 nm or less. The reason of this regulation is that a problem arises that when the ultraviolet ray transmission factor of the aforementioned bulbs is higher than 40% at a wavelength of 300 nm or less, the ultraviolet ray transmission amount of the aforementioned bulbs is increased, so that for example, a member formed by synthetic resin and arranged around the aforementioned bulbs is deteriorated and the life span of the member is shortened.

Further, when a glass bulb is structured as mentioned above, miniaturization of a fluorescent lamp is realized, and the ultraviolet ray radiation amount per unit glass area is increased in correspondence with reduction in the tube diameter, and ultraviolet rays are easily transmitted by making the bulb thinner, so that a remarkable effect of preparation of an ultraviolet ray reduction material can be produced.

The ultraviolet ray transmission factor of the aforementioned bulbs is preferably 10% to 40% at a wavelength of 300 nm or less. The reason of the regulation of that the ultraviolet ray transmission factor of the aforementioned bulbs is preferably 10% to 40% at a wavelength of 300 nm or less is that when the ultraviolet ray transmission factor of the aforementioned bulbs is reduced, the transmission factor of visible light has a tendency to reduce, and when the ultraviolet ray transmission factor of the aforementioned bulbs is within the aforementioned range, the ultraviolet ray transmission of the aforementioned bulbs can be suppressed effectively, and the reduction in the transmission factor of visible light due to the reduction in the ultraviolet ray transmission factor is little, so that sufficient brightness can be kept.

(Glass Composition)

Glass of a bulb is composed of soft glass having the aforementioned constitution and containing substantially no lead practically. Next, each component will be explained hereunder. Each component ratio means weight percent.

Containing lead-free component practically means that some impurities may be contained and the content is preferably 0.1 wt-% or less, more preferably 0.01 wt-% or less. Needless to say, a glass bulb containing lead-free component at all is most preferable.

The content of sodium oxide of 11 wt-% or less includes a case that no sodium oxide is contained in a glass bulb.

The reason of the regulation of the content of sodium oxide of 11 wt-% or less is that when the content is more than the aforementioned value, the sodium component educed on the inner wall of the glass bulb is increased in amount and a reduction in the visible light transmission factor due to coloring is caused.

Furthermore, the content of sodium oxide is preferably 1 to 11 wt-%. The reason that the aforementioned range is preferable is that when the content of sodium oxide is reduced to less than 1 %, the material cost is increased extremely.

With respect to the other components, it is preferable that the content of potassium oxide (K₂O) is 1 to 10 wt-% and the content of lithium oxide (Li₂O) is 3 wt-% or less. Further, the total of sodium oxide, potassium oxide, and lithium oxide is preferably within the range from 5 to 20 wt-%. Potassium oxide and lithium oxide function to lower the softening point and melting point of a glass bulb in the same way as with sodium oxide. The reason that the total of sodium oxide, potassium oxide, and lithium oxide is preferably within the range from 5 to 20 wt-% is that when the total is below the range, the viscosity increases, and the solubility lowers, and the thermal coefficient of expansion lowers extremely and when the total is beyond the range, the chemical durability lowers and the thermal coefficient of expansion increases extremely.

Further, it is more preferable that a glass bulb contains antimony oxide (Sb₂O₃) of 0.1 to 0.5 wt-%. The reason that the content of antimony oxide is set within the aforementioned range is that it is a suitable range for adopting the oxide clarify method.

No-lead glass of the present invention has an ultraviolet ray reduction material, so that the ultraviolet ray transmission factor at a wavelength of 300 nm or less can be suppressed to 40%. The ultraviolet ray reduction material is a material for absorbing or reflecting ultraviolet rays (a wavelength of 380 nm or less) and concretely, for example, a metallic oxide and synthetic resin may be cited. Further, as a metallic oxide, for example, one or two or more metallic oxides selected from a group composed of ferric oxide (Fe₂O₃), cerium oxide (CeO₂), titanium oxide (TiO₂), aluminum oxide (Al₂O₃), and zinc oxide (ZnO) are preferable. The reason that these metallic oxides arc preferable is that they can absorb or reflect more ultraviolet rays, so that the ultraviolet ray transmission of the aforementioned bulb formed by lead-free glass can be suppressed surely.

In consideration of effects of glass on the electrical characteristics, chemical characteristics, and visible light transmission factor, an ultraviolet ray reduction material is preferably Fe₂O₃, CeO₂, or a combination thereof and particularly use of CeO₂ is desirable. The reason is that Al₂O₃ and ZnO are inferior to Fe₂O₃ and CeO₂ in the ultraviolet ray absorption capacity, so that it is necessary to mix a comparatively large amount and TiO₂ absorbs also visible light at a wavelength of 400 nm or more slightly. Fe₂O₃ has a high ultraviolet ray absorption capacity, though it also absorbs visible light slightly, so that CeO₂ is most preferable.

When an ultraviolet ray reduction material is not mixed in the aforementioned bulb, by forming a layer having an ultraviolet ray reduction material on the inner wall or outer wall of the bulb, the equivalent effect can be obtained. In this case, the inner wall or outer wall of the bulb includes both cases that it is in contact with the bulb directly or indirectly. As a layer, for example, a case that an ultraviolet ray reduction material is formed in a film or a case that an ultraviolet ray reduction material is coated may be cited. When an ultraviolet ray reduction material is to be formed in layers, in consideration of the optical characteristics, TiO₂, ZnO, CeO₂, or a combination thereof may be used.

A phosphor layer may be directly formed on the inner surface of a bulb or may be indirectly formed via a protective film such as alumina or a reflection film such as titanium oxide.

A phosphor to be used can be optionally selected according to the illumination object. For example, for a general illumination use: a three-wavelength type phosphor with a blue series phosphor, green series phosphor, and red series phosphor mixed or a white luminescent phosphor such as a whitish illumination phosphor can be used.

In this case, rare gas is preferably, for example, argon gas or krypton gas and rare gas includes mixed rare gas.

A fluorescent lamp having the aforementioned constitution has an ultraviolet ray reduction material composed of a metallic oxide, so that the tube wall load of a bulb formed by lead-free glass is 0.05 W/cm² or more, thus the ultraviolet ray radiation amount is increased. However, since the glass bulb is formed by lead-free glass that the ultraviolet ray transmission amount is suppressed, the effect of radiation of ultraviolet rays can be reduced. Namely, when the tube wall load is increased, the radiated ultraviolet ray intensity is increased and when the tube wall load is 0.05 W/cm² or more, ultraviolet rays radiated from lead-free glass having a content of sodium oxide of 11 wt-% or less cannot be ignored, so that it has a remarkable effect on a fluorescent lamp lighting under the condition of a tube wall load of 0.05 W/cm² or more. When the tube wall load exceeds 0.07 W/cm², the ultraviolet ray radiation amount is increased more and the effect by radiated ultraviolet rays is larger than a general fluorescent lamp, so that it produces a particularly remarkable effect. When the tube wall load exceeds 0.1 W/cm², the radiation amount is increased so that even a position at a distance of 30 cm or more from the glass bulb is affected by ultraviolet rays, thus it produces a more remarkable effect.

As a result, for example, even when a member arranged around the aforementioned bulb is formed by synthetic resin, the member can be prevented from deterioration.

In this case, as a member arranged around a fluorescent lamp, concretely, for example, a member formed by synthetic resin or a member with paint coated on its surface may be cited.

As one cause of deterioration of a member formed by synthetic resin, it may be considered that for example, synthetic resin is generally composed of high polymer molecules, and those high polymer molecules have an absorption characteristic of ultraviolet rays, so that they absorb ultraviolet rays and is put into an excitation state, and when the excitation energy cannot be output efficiently, the main chains and side chains of high polymer molecules are broken.

The deterioration mentioned above includes, for example, cracks, color change to yellow or milky white, or separation of low polymer molecules in the synthetic resin.

Further, since the aforementioned bulb is formed by lead-free glass, no lead is released when a used fluorescent lamp is abolished and environmental pollution can be prevented.

Further, when a glass bulb is structured as mentioned above, miniaturization of a fluorescent lamp is realized, and the ultraviolet ray radiation amount per unit glass area is increased in correspondence with reduction in the tube diameter, and ultraviolet rays are easily transmitted by making the bulb thinner, so that a remarkable effect of preparation of an ultraviolet ray reduction material can be produced.

A fluorescent lamp having the constitution of an embodiment of the present invention is characterized in that it has a glass bulb containing lead-free component practically, containing sodium oxide of 11 wt-% or less, and having an ultraviolet ray transmission factor of 40% or less at a wavelength of 300 nm or less, mercury and rare gas sealed in the glass bulb, a pair of discharge electrodes for causing discharge in the glass bulb, and a phosphor layer formed on the inner wall of the glass bulb and lights when the tube wall load is 0.05 W/Cm² or more.

In a self-ballasted fluorescent lamp having the constitution of another embodiment of the present invention, the tube diameter of the aforementioned glass bulb is 18 mm or less and the thickness is 0.5 to 1.5 mm and by use of such a constitution, miniaturization of a fluorescent lamp is realized and the ultraviolet ray radiation amount per unit glass area is increased in correspondence with reduction in the tube diameter, and ultraviolet rays are easily transmitted by making the bulb thinner, so that a remarkable effect of preparation of an ultraviolet ray reduction material can be produced.

In a self-ballasted fluorescent lamp having the constitution of another embodiment of the present invention, the bulb has a U-shaped bent part and further has a cover for supporting the fluorescent lamp, a screw base attached to the cover, and a lighting circuit, which is housed in the cover and electrically connected to the screw base, for lighting the fluorescent lamp.

Further, the self-ballasted fluorescent lamp may have or may not have a globe for protecting the bulb.

In the self-ballasted fluorescent lamp having the constitution of the aforementioned embodiment, the bulb has a U-shaped bent part, so that the fluorescent lamp can be made compact.

Even when a self-ballasted fluorescent lamp has no globe for protecting the bulb, ultraviolet rays generated in the bulb are reduced by the bulb, so that the effect by ultraviolet rays can be reduced and for example, a member formed by synthetic resin arranged around the bulb can be prevented from deterioration.

A fluorescent lamp having the constitution of still another embodiment of the present invention is characterized in that it has a glass bulb containing lead-free component practically, containing sodium oxide of 11 wt-% or less, and containing an iron component of 0.06 wt-% or less of reduced ferric oxide, mercury and rare gas sealed in the glass bulb, a pair of discharge electrodes for causing discharge in the glass bulb, and a phosphor layer formed on the inner wall of the glass bulb having a blue series phosphor activated by dihydric europium or a blue series phosphor activated by dihydric europium and magnesium and lights when the tube wall load is 0.07 W/cm² or less.

A fluorescent lamp having the constitution of still another embodiment of the present invention is characterized in that it has a glass bulb containing lead-free component practically, containing sodium oxide of 11 wt-% or less, and containing an iron component of 0.06 wt-% or less of reduced ferric oxide, mercury and rare gas sealed in the glass bulb, a pair of discharge electrodes for causing discharge in the glass bulb, a phosphor layer formed on the inner wall of the glass bulb, and a protective film which is formed between the glass bulb and the phosphor and has a function for suppressing reaction between the sodium component in the glass bulb and the aforementioned mercury and also absorbing ultraviolet rays and lights when the tube wall load is 0.07 W/cm² or less.

The iron component indicates both of iron oxide and ferric oxide. Iron oxide has a function for absorbing ultraviolet rays.

A content of iron component of 0.06 wt-% or less of reduced ferric oxide includes a case that no iron component is contained in a glass bulb.

A glass bulb may be formed by either of the oxidation clarify method and reduction clarify method. When a glass bulb is formed by the oxidation clarify method, the content of ferric oxide is increased and when a glass bulb is formed by the reduction clarify method, the content of iron oxide is increased.

The phosphor may be a blue series phosphor activated by dihydric europium (Eu) or a blue series phosphor activated by dihydric europium and magnesium (Mg).

A blue series phosphor is referred to as a phosphor for emitting blue series light by incidence of ultraviolet rays.

As a blue series phosphor activated by dihydric europium or a blue series phosphor activated by dihydric europium and magnesium, concretely, for example, bluish illumination phosphor activated by dihydric europium and manganese, magnesium phosphor (BaMgAl₁₀O₁₇:Eu, Mn), divalant europium activated by dihydric europium, or alkaline earth divalant europium phosphor (BaMgAl₁₀O₁₇:Eu) activated by dihydric europium may be cited.

The aforementioned phosphor may include a blue series phosphor activated by dihydric europium or a blue series phosphor activated by dihydric europium and magnesium. As a result, the aforementioned glass bulb can absorb ultraviolet rays in the transmittable wavelength range and suppress ultraviolet rays transmitting the glass bulb.

The aforementioned phosphor additionally has a green series phosphor and a red series phosphor and can form the aforementioned blue series phosphor between the glass bulb and the green series phosphor and red series phosphor.

A green series phosphor is referred to as a phosphor for emitting green series light by incidence of ultraviolet rays and as a green series phosphor, for example, lantern phosphate phosphor (LaPO₄:Ce, Tb) activated by cerium and terbium may be cited.

A red series phosphor is referred to as a phosphor for emitting red series light by incidence of ultraviolet rays and as a red series phosphor, for example, yttrium oxide phosphor (Y₂O₃:Eu) activated by trivalent europium may be cited.

When the aforementioned blue series phosphor is formed between the aforementioned glass bulb and the aforementioned green series phosphor and aforementioned red series phosphor as mentioned above, light at a low color temperature can be produced.

The reason that the tube wall load is specified as 0.07 W/cm² or less is that when the tube wall load is lower than the value, ultraviolet rays radiated from the phosphor and mercury vapor are little, so that even when a lead-free glass bulb is used, by adding a film having a brief ultraviolet ray absorption function to the glass bulb, radiation of ultraviolet rays to the glass bulb is suppressed and the members arranged around the fluorescent lamp are hardly deteriorated by ultraviolet rays.

A protective film having an ultraviolet ray absorption function may be arranged on the inner surface of a bulb as required.

As a protective film, a film constitution mainly using fine particles of Al₂O₃, TiO₂, ZnO, or CeO₂ may be used. The crystal structure of Al₂O₃ may be either of the β type and α type.

The protective film mentioned above may be either of a film having both of a function for suppressing reaction of the sodium component in a glass bulb and mercury and a function for absorbing ultraviolet rays and a film which is divided into a film having a function for suppressing reaction of the sodium component in a glass bulb and mercury and a film having a function for absorbing ultraviolet rays.

In a fluorescent lamp having the constitution of one of the aforementioned two embodiments, the tube wall load is 0.07 W/cm² or less, so that by adding a film having an ultraviolet ray absorption function to a lead-free glass bulb, the transmission amount of ultraviolet rays can be reduced.

A fluorescent lamp having the constitution of still another embodiment of the present invention is characterized in that it has a glass bulb containing lead-free component practically, containing sodium oxide of 11 wt-% or less, and having an ultraviolet ray transmission factor of 35% at a wavelength of 300 nm with a thickness of 0.8 mm.

Using the aforementioned constitution, the fluorescent lamp can reduce the sodium component educed on the inner wall of the glass bulb, also suppress ultraviolet rays transmitting the glass bulb, and reduce the effect by ultraviolet rays.

A protective film may be formed by mixing two or more metallic oxides having both of the protection function and the ultraviolet ray absorption function. The particle diameter of metallic oxides is preferably about 0.1 μm or less. The reason that the aforementioned numerical value is preferable is that when the particle diameter is more than the value, the contact of the sodium component educed on the glass bulb with mercury vapor cannot be prevented effectively. The particle diameter of metallic oxides is more preferably about 0.02 to 0.04 μm.

A protective film is formed, for example, by adding a binder solution to a metallic oxide to produce a suspension and then coating, drying, and calcining it on the inner wall of a glass bulb.

The thickness of protective film is preferably about 0.1 to 1.0 μm. The reason that the range is preferable is that when the thickness is beyond the range, the protective film also absorbs visible light emitted from the phosphor and the brightness is reduced and when the thickness is below the range, the protective film cannot suppress ultraviolet rays transmitting the glass bulb effectively.

According to the fluorescent lamp of the aforementioned embodiment, a protective film including a metallic oxide having both of the protection function and the ultraviolet ray absorption function is formed between the glass bulb and the phosphor, so that the protective film can suppress ultraviolet rays transmitting the glass bulb without reducing the light flux and reduce the effect by ultraviolet rays.

Since the protective film has both functions, it can be formed by one kind of metallic oxide, thus the protective film can be made thin.

A fluorescent lamp having the constitution of still another embodiment of the present invention is characterized in that the aforementioned protective film additionally contains a first metallic oxide having the function for suppressing reaction of the sodium component and mercury and a second metallic oxide having the ultraviolet ray absorption function.

As a first metallic oxide, concretely, for example, aluminum oxide (Al₂O₃) may be cited.

As a second metallic oxide, concretely, for example, one or two or more metallic oxides selected from a group composed of titanium oxide (TiO₂), zinc oxide (ZnO), and cerium oxide (CeO₂) may be cited. In this case, a second metallic oxide may have the ultraviolet ray absorption function and as another function, a metallic oxide may have a function for suppressing reaction of the sodium component and mercury.

Using the aforementioned constitution, in the fluorescent lamp, the aforementioned protective film can be formed thinly and the cost can be reduced.

In still another embodiment of the fluorescent lamp, the aforementioned protective film is characterized in that it is structured in layers divided into a first metallic oxide film including the first metallic oxide and a second metallic oxide film including the second metallic oxide.

Using the aforementioned constitution, the fluorescent lamp can reduce surely reaction of the sodium component educed on the inner wall of the glass bulb with mercury, also surely suppress ultraviolet rays transmitting the glass bulb, and reduce the effect by ultraviolet rays.

A fluorescent lamp having the constitution of still another embodiment of the present invention is characterized in that it has a glass bulb containing lead-free component practically, containing sodium oxide of 11 wt-% or less, and having an ultraviolet ray transmission factor of 10% or more at a wavelength of 300 nm or less, mercury and rare gas sealed in the glass bulb, a pair of discharge electrodes for causing discharge in the glass bulb, and a phosphor layer with a thickness of 10 μm or more formed on the inner surface of the glass bulb.

The ultraviolet ray transmission factor means a one in a state that no phosphor is coated on a bulb and can be measured by a glass piece having the same thickness as that of a bulb.

The aforementioned bulb may be a bulb in a shape having a bent part such as a double U, a triple U, or a ring or in a shape of a linear tube, though it is not limited to them.

The reason of the regulation that the ultraviolet ray transmission factor of a bulb is 10% or more at a wavelength of 300 nm or less is that when the ultraviolet ray transmission factor at a wavelength of 300 nm or less is less than 10%, the effect of ultraviolet rays is little.

For example, when the ultraviolet ray transmission factor of a bulb is 10% or more, the ultraviolet ray transmission amount is increased and a problem arises that an article to be emitted arranged in the neighborhood of the fluorescent lamp, for example, a member such as a lighting fixture part formed by synthetic resin or a building material formed by a material having a color deterioration property is deteriorated.

Further, the ultraviolet ray transmission factor at a wavelength of 300 nm or less is preferably 20% to 50%. The reason that this preferable range is specified is that when the ultraviolet ray transmission factor of a bulb is reduced, the transmission factor of visible light has a tendency to reduce, and when the ultraviolet ray transmission factor of a bulb is within the aforementioned range, the ultraviolet ray transmission of the bulb can be suppressed effectively, and the reduction in the transmission factor of visible light due to the reduction in the ultraviolet ray transmission factor is little, so that sufficient brightness can be kept.

The phosphor layer is directly or indirectly coated and formed on the inner surface of a bulb via a protective film and the film thickness is 10 μm or more. The film thickness is not uniform often in the inner surface of a bulb because the phosphor layer is coated in a slurry state. In this case, the film thickness is defined by the film thickness at a position of minimum film thickness.

The phosphor layer absorbs ultraviolet rays, converts them to visible light, and emits it, so that it is found that when the film is made thicker than the conventional one so as to enhance the absorption capacity of ultraviolet rays and the film thickness is set to 10 μm or more, even for a bulb using lead-free glass, the ultraviolet ray transmission amount is reduced at a wavelength of 300 nm or less.

There are no special restrictions on the phosphor kind to be used for a phosphor layer. However, it is preferable to use a rare-earth phosphor such as a three-wavelength luminous phosphor. As a three-wavelength luminous rare-earth phosphor, BaMg₂Al₁₆O₂₇:Eu²⁺ as a blue series phosphor having a luminous peak wavelength in the neighborhood of 450 nm, (La, Ce, Tb) PO₄ as a green series phosphor having a luminous peak wavelength in the neighborhood of 540 nm, and Y₂O₃:Eu³⁺ as a red series phosphor having a luminous peak wavelength in the neighborhood of 610 nm can be applied. However, there are no restrictions on them.

BaMg₂Al₁₆O₂₇:Eu²⁺ for emitting blue series light and (La, Ce, Tb) PO₄ for emitting green series light have a high ultraviolet ray absorption capacity, so that a fluorescent lamp of light color using a large amount of these phosphors has a suppression effect on ultraviolet ray transmission even when the film thickness is thin such as 10 μm or so.

Further, in the aforementioned fluorescent lamp, when the lamp current per unit sectional area of the glass bulb is 200 mA/cm² or more, the effect appears more remarkably The sectional area of glass bulb means a sectional area of the inner space of the bulb in the orthogonal direction to the longitudinal direction of the bulb. The lamp current is a current supplied to the fluorescent lamp and does not include a current flowing only in the light circuit.

In a fluorescent lamp having a variable light quantity, the lamp current is defined by a maximum lamp current within the lighting controllable range such as a high output lighting state in the normal operation state. Therefore, a lamp current in the last period of life or in the abnormal lighting state is not included.

When the lamp current per unit sectional area of a glass bulb, that is, the lamp current density is 200 mA/cm² or more, the transmission amount of ultraviolet rays increases, so that the ultraviolet ray absorption function by the phosphor layer is fulfilled more effectively.

According to a fluorescent lamp using the constitution of the aforementioned embodiment, even a bulb using lead-free glass having an ultraviolet transmission factor of 10% or more at a wavelength of 300 nm or less is formed by a phosphor layer with a film thickness of 10 μm or more, so that the ultraviolet ray transmission amount is reduced and the effect of radiation of ultraviolet rays on neighboring articles to be emitted can be suppressed.

When the Na component in glass is reacted with mercury entering the glass, a fluorescent lamp is caused to be colored in blackish brown. Further, the Na component educed on the glass surface is reacted with mercury, and a mercury compound is produced, and a reduction in the light flux maintenance rate may be caused (so-called ultraviolet ray solarization). Therefore, by keeping sodium oxide in the bulb glass in 11% or less, preferably 10 wt-% or less, the aforementioned problem can be suppressed.

Namely, since sodium oxide contained in the glass is reduced to 11 wt-% or less, the reduction in the light flux maintenance rate can be suppressed.

A self-ballasted fluorescent lamp having the constitution of still another embodiment of the present invention is characterized in that it has a fluorescent lamp having a tube diameter of the glass bulb of 18 mm or less and a thickness of 0.5 to 1.5 mm, a cover for supporting the fluorescent lamp, a screw base attached to the cover, and a lighting circuit electrically connected to the screw base and housed in the cover for lighting the fluorescent lamp.

Using the constitution of the aforementioned embodiment, a self-ballasted fluorescent lamp having the function of the fluorescent lamp having the constitution of the aforementioned fifth embodiment can be provided.

When a glass bulb is structured as mentioned above, miniaturization of a fluorescent lamp is realized, and the ultraviolet ray radiation amount per unit glass area is increased in correspondence with reduction in the tube diameter, and ultraviolet rays are easily transmitted by making the bulb thinner, so that a remarkable effect of preparation of an ultraviolet ray reduction material can be produced.

A self-ballasted fluorescent lamp having the constitution of still another embodiment of the present invention is characterized in that it has amalgam, and the glass contains SiO₂ of 60 to 75 wt-%, Al₂O₃ of 1 to 5 wt-%, Li₂O of 1 to 5 wt-%, Na₂O of 5 to 10 wt-%, K₂O of 1 to 10 wt-%, CaO of 0.5 to 5 wt-%, MgO of 0.5 to 5 wt-%, SrO of 0.5 to 10 wt-%, and BaO of 0.5 to 7 wt-% and has a composition of SrO/BaO≧1.5 and MgO+BaO≦SrO, and the amalgam for feeding mercury vapor is introduced into the glass bulb.

The amalgam is prepared as a feed source of mercury vapor of a discharge medium. The amalgam has a high temperature type of most suitable mercury vapor pressure and a low temperature type close to pure mercury (liquid mercury) and either of them is acceptable. As the high temperature type, for example, amalgam having a composition of Bi—In—Hg or Bi—In—Sn—Hg may be used. In this case, to make the start-up of brightness good, amalgam containing mercury of 4.5 wt-% or more can be used. As the low temperature type, for example, Bi—Su—Hg or Bi—Pb—Hg can be used. When amalgam is to be used, it may be sealed directly into a bulb or it is possible to leave amalgam in the exhaust tube and make only the mercury vapor pressure function inside the bulb. Furthermore, the equipment may be structured so as to use the aforementioned amalgam as main amalgam and in addition to it, accelerate start-up of the mercury vapor pressure at start time by using auxiliary amalgam composed of a metal such as indium for adsorbing mercury vapor in the bulb and easily forming amalgam. The auxiliary amalgam can be arranged in the neighborhood of the electrode or at the middle of the discharge path.

According to the present invention, since a bulb is structured using soft glass composed of the aforementioned predetermined composition, the glass has a suitable charging tendency (electronegativity) and the window where the glass is exposed in the discharge space is given a proper mercury adsorption property. Therefore, while the fluorescent lamp is off, the window of the bulb is adsorbed with mercury. As the window of the bulb, the sealing part or for example, the connection of the U-shaped glass tube with the connection tube may be used, so that no special structure is required and it may be dispersed properly in the longitudinal direction of the bulb.

Then, when the fluorescent lamp is lit, mercury adsorbed in the window of the bulb is released simultaneously and diffused into the bulb. Therefore, the start-up of brightness at a very early stage of lighting, that is, within about 10 seconds is accelerated.

Additional objects and advantages of the present invention will be apparent to persons skilled in the art from a study of the following description and the accompanying drawings, which are hereby incorporated in and constitute a part of this specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a cross sectional view schematically showing a self-ballasted fluorescent lamp having the constitution of the first embodiment of the present invention;

FIG. 2 is a schematic view showing the bottom of the self-ballasted fluorescent lamp shown in FIG. 1;

FIG. 3 is a cross sectional view schematically showing the inside of the bulb of the self-ballasted fluorescent lamp shown in FIG. 1;

FIG. 4 is a graph showing ultraviolet ray transmission characteristics of bulbs relating to a manufacture example and a comparative of self-ballasted fluorescent lamps having the constitution of the first embodiment of the present invention;

FIG. 5 is an enlarged cross sectional view schematically showing a bulb of a self-ballasted fluorescent lamp having the constitution of the second embodiment of the present invention;

FIG. 6 is an enlarged cross sectional view schematically showing a bulb of a self-ballasted fluorescent lamp having the constitution of the third embodiment of the present invention;

FIG. 7 is a cross sectional view schematically showing a deformation example of the self-ballasted fluorescent lamp shown in FIG. 1;

FIG. 8 is a plan view schematically showing a fluorescent lamp having the constitution of the fourth embodiment of the present invention;

FIG. 9 is a cross sectional view schematically showing the electrode part of the fluorescent lamp shown in FIG. 8;

FIG. 10 is a graph showing ultraviolet ray transmission characteristics of glass bulbs of self-ballasted fluorescent lamps having the constitution of the fourth embodiment of the present invention;

FIG. 11 is a cross sectional view schematically showing an enlarged glass bulb of a fluorescent lamp having the constitution of the fifth embodiment of the present invention;

FIG. 12 is a cross sectional view schematically showing an enlarged glass bulb of a fluorescent lamp having the constitution of the sixth embodiment of the present invention;

FIG. 13 is a graph showing ultraviolet ray transmission characteristics of glass bulbs of self-ballasted fluorescent lamps having the constitution of the sixth embodiment of the present invention;

FIG. 14 is a cross sectional view schematically showing an enlarged glass bulb of a fluorescent lamp having the constitution of the seventh embodiment of the present invention;

FIG. 15 is a cross sectional view schematically showing an enlarged glass bulb of a fluorescent lamp having the constitution of the eighth embodiment of the present invention;

FIG. 16 is a development elevation of a bulb of a fluorescent lamp having the constitution of the ninth embodiment of the present invention; and

FIG. 17 is an enlarged view showing a bending part of one U-shaped tube of the fluorescent lamp shown in FIG. 16.

### DESCRIPTION OF THE PREFERRED EMBODIMENTS

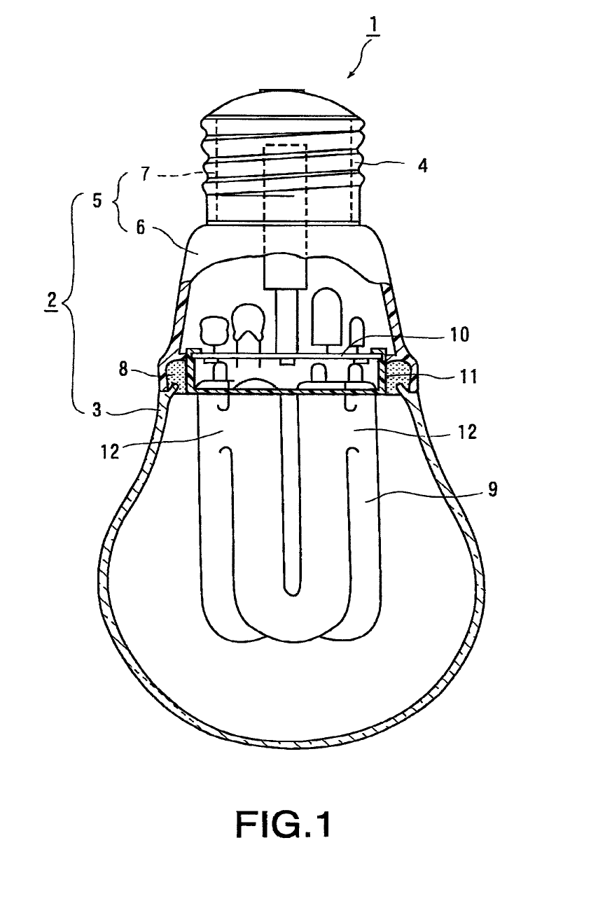

The present invention will be described in detail with reference to the FIGS. 1 through 17.

First, a fluorescent lamp having the constitution of the first embodiment of the present invention will be explained.

In the constitution of the first embodiment, a self-ballasted fluorescent lamp will be explained.

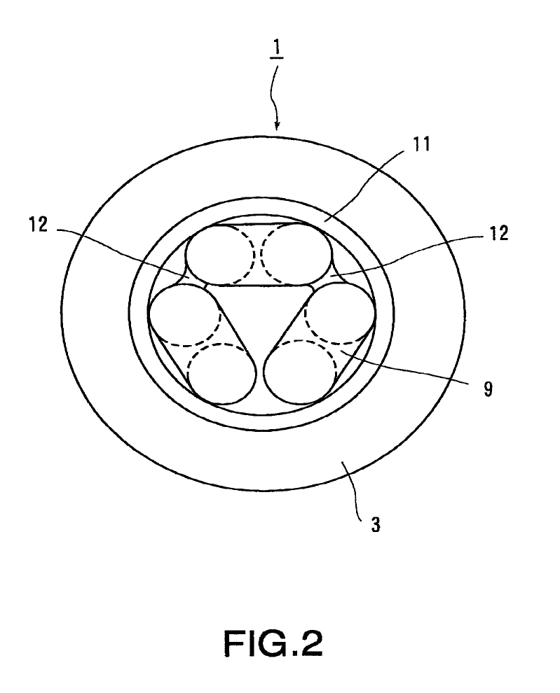

FIG. 1 is a cross sectional view schematically showing a self-ballasted fluorescent lamp having the constitution of the first embodiment and FIG. 2 is a bottom view thereof.

As shown in FIGS. 1 and 2, a self-ballasted fluorescent lamp 1 having the constitution of the first embodiment has an outer container 2. The outer container 2 is composed of a light transmission globe 3 for protecting the fluorescent lamp and a cover 5 having a screw base 4.

The globe 3 may be shaped optionally and in the constitution of the first embodiment, a globe which is formed in a smooth curved surface which is almost the same shape as that of a glass globe of an incandescent lamp and equipped with an opening will be explained.

The globe 3 is formed, for example, by a transparent material such as glass or synthetic resin or a diffusion transmissive material and the light distribution or light color of light radiated from the fluorescent lamp can be changed.

The cover 5 is structured so that a hollow and conical tube 6 and a small-diameter cylinder 7 are integrated at the upper end of the tube 6. The lower end of the tube 6 of the cover 5 and the edge of the globe 3 in the neighborhood of the opening are fixed, for example, by silicon-based heat-hardening adhesive 8.

The cover 5 is formed by synthetic resin having an excellent heat resistance such as polythylene terephthalate (PET) or polybutylene terephthalate (PBT).

To the small-diameter cylinder 7 of the cover 5, for example, the screw base 4 formed by a conductive material such as brass or aluminum is fixed by an adhesive or by calking, and power is supplied to a lighting circuit 10, which will be described later, from an outer power source not shown in the drawing via the screw base 4, and a voltage is applied between a pair of electrodes 24.

The screw base 4 is a screw type base such as Edison type E26.

Inside the outer container 2 composed of the globe 3 and the cover 5, a fluorescent lamp 9 composed of three bulbs bent in a U-shape, the lighting circuit 10 for lighting the fluorescent lamp 9, and a holder 11 for supporting the fluorescent lamp 9 and the lighting circuit 10 are arranged. The fluorescent lamp 9 is fixed to the holder 11 by silicone adhesive and supported by the cover 5 indirectly.

The lighting circuit 10 is structured mainly by, for example, a stabilizer for limiting the lamp current to a specified value and concretely, for example, a plurality of electronic parts such as an electrolytic condenser and a transistor are arranged on both sides of the almost circular circuit substrate.

Further, the lighting circuit 10 is supported by the holder 11, thereby housed in the cover 5.

The holder 11 is formed in a cylindrical shape having a bottom, and at the bottom, an opening for inserting the end of the fluorescent lamp 9 bent in a U-shape and supporting it almost perpendicularly is formed, and a silicone adhesive is coated in the neighborhood of the opening so as to fix the fluorescent lamp 9.

Further, the holder 11 is formed, for example, by one or two or more thermoplastic synthetic resins, which are not softened at the highest temperature (for example, about 100 to 120° C.) during lighting, selected from a group composed of polyethylene terephthalate, polybutylene terephthalate, polypropylene, 4-ethylene fluoride, and polycarbonate. Since the holder 11 is formed by synthetic resin, it can be easily manufactured and the manufacturing cost can be reduced.

Further, the synthetic resin forming the holder 11 contains a metal oxide of 5 wt-% or more of the weight of the holder 11. The metal oxide is more preferably one or two or more metal oxides, for example, selected from a group composed of ferric oxide (Fe₂O₃), cerium oxide (CeO₂), titanium oxide (TiO₂), aluminum oxide (Al₂O₃), and zinc oxide (ZnO).

Further, the holder 11 is provided with a pawl and a stepped part, and the lighting circuit 10 is loaded on the stepped part and held by the pawl, thus the lighting circuit 10 can be supported.

Furthermore, the silicon-based heat-hardening adhesive 8 for fixing the globe 3 and the cover 5 is in contact with the side of the holder 11, thus the holder 11 is fixed to the outer container 2 composed of the globe 3 and the cover 5.

The fluorescent lamp 9 is structured so as to connect three bulbs bent in a U-shape. The fluorescent lamp 9 has connection tubes 12 at the two positions where the ends of the three U-shaped bulbs are neighboring to each other, and the respective U-shaped bulbs are connected to each other by these connection tubes 12 and 12, thus the fluorescent lamp 9 forms a discharge line.

The outer tube diameter of the bulbs constituting the fluorescent lamp 9 is 11 mm, and the inner tube diameter is 9 mm, and the discharge line length is 350 mm.

Next, the bulb and bulb inside of a fluorescent lamp having the constitution of the first embodiment will be explained.

In this case, a bulb 20 having the constitution of the first embodiment bent in a U-shape uses lead-free glass containing no lead oxide practically.

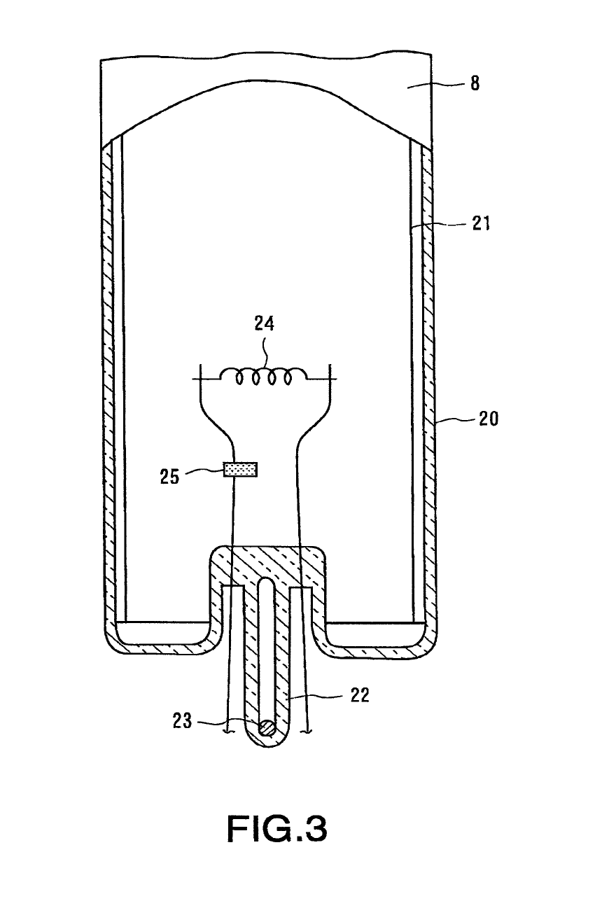

FIG. 3 is a cross sectional view schematically showing the structure of the end of the bulb 20 of the self-ballasted fluorescent lamp 9 having the constitution of the first embodiment.

As shown in FIG. 3, the bulb 20 is formed by lead-free glass and the bulb 20 contains, for example, a metal oxide, for reflecting or absorbing ultraviolet rays, of 0.05 to 3.0 wt-% or more of, for example, the weight of the bulb 20 as an ultraviolet ray reduction material for reducing ultraviolet rays. The metal oxide is preferably one or two or more metal oxides selected, for example, from a group composed of ferric oxide (Fe₂O₃), cerium oxide (CeO₂), titanium oxide (TiO₂), aluminum oxide (A1₂O₃), and zinc oxide (ZnO). Further, among them, for example, ferric oxide (Fe₂O₃), cerium oxide (CeO₂), or a mixture of ferric oxide (Fe₂O₃) and cerium oxide (CeO₂) is more preferable.

Further, the bulb 20 contains sodium oxide of 11 wt-% or less, preferably 10 wt-% or less of the weight thereof.

Furthermore, the bulb 20 preferably contains antimony oxide (Sb₂O₃) of 0.05 wt-% or less of the weight thereof. In this case, antimony oxide of 0.05 wt-% or less includes a case that the bulb 20 contains no antimony oxide. The reason that the content of antimony oxide is specified as less than the aforementioned value is that a bulb formed by the clarify method using antimony oxide can increase the brightness, though antimony oxide is an injurious material, so that environmental pollution may be caused. Therefore, by controlling the content of antimony oxide to 0.05 wt-% or less of the weight of the bulb 20, environmental pollution can be prevented.

In the bulb 20, mercury gas and rare gas such as argon or krypton are sealed and mercury gas and rare gas are ionized by discharge between a pair of electrodes 24 which will be described later.

On the inner wall of the bulb 20, for example, a phosphor layer 21 composed of a three-wavelength phosphor activated by a rare-earth element having a luminous peak wavelength in the wavelength ranges of 440 to 460 nm, 540 to 560 nm, and 600 to 620 nm is formed and visible light is generated by ultraviolet rays radiated from excited mercury atoms.

At least at one end of the bulb 20 is formed smaller diameter than the exhaust tube 22. An amalgam 23 is sealed in the exhaust tube 22. The amalgam 23 controls the mercury vapor pressure to prevent reduction in the brightness when the temperature of the bulb 20 will rise.

Further, at a pair of ends of the three connected bulbs 20, filament electrodes 24 for generating discharge are arranged respectively. On the pair of electrodes 23, a thermion emissive material such as barium oxide, potassium oxide, or strontium oxide is coated on the filament coil thereof and when the filament coil is preheated or a voltage is applied between the electrodes 24, thermions are emitted from the thermion emissive material of the electrodes 24.

Furthermore, in the inner lead wires for supporting the electrodes 24, auxiliary amalgam 25 is provided. By emitting mercury contained in the auxiliary amalgam 25 immediately after lighting, the light flux can be suddenly started up immediately after lighting and the light flux can be stabilized earlier.

The self-ballasted fluorescent lamp 1 is structured so as to light at power consumption of 12 W, and the power to be supplied to the fluorescent lamp 9 at this time is 10 W. and the tube wall load is about 0.1 W/cm².

Next, the lighting operation of the self-ballasted fluorescent lamp 1 having the constitution of the first embodiment and the ultraviolet ray transmission reduction function of the bulb 20 will be explained.

To light the self-ballasted fluorescent lamp 1 having the constitution of the first embodiment, firstly, power is supplied to the lighting circuit 10 from an external power source not shown in the drawing via the screw base 4. When power is input to the lighting circuit 10, the filament coils of the pair of electrodes 24 are preheated respectively and a voltage is applied between the pair of electrodes 24. Then, thermions are emitted from the thermion emissive material of the electrodes 24, accelerated and moved to collide with mercury gas and rare gas, and excite mercury atoms. Excited mercury atoms radiate ultraviolet rays of mainly 253.7 nm and 185 nm and excite the phosphor layer 21 formed on the inner wall of the bulb 20. Visible light is generated from the excited phosphor layer 21 and the self-ballasted fluorescent lamp 1 lights.

The self-ballasted fluorescent lamp 1 having the constitution of the first embodiment lights under a high tube wall load condition and much ultraviolet rays are radiated from mercury atoms. However, most of ultraviolet rays are absorbed by the ultraviolet ray reduction material in the bulb 20 and the ultraviolet ray amount radiated from the bulb 20 can be reduced.

Concretely, when the bulb 20 contains an ultraviolet ray reduction material, for absorbing ultraviolet rays, of 0.05 to 3.0 wt-% of the weight of the bulb 20, the ultraviolet ray transmission factor of the bulb 20 can be reduced to 40% or less at 300 nm or less.

Further, by adjusting the content of ultraviolet ray reduction material, the ultraviolet ray transmission factor of the bulb 20 can be reduced to 10 to 40% at 300 nm or less.

As a result, the effect of ultraviolet rays on a member formed by synthetic resin and arranged around the fluorescent lamp 9 such as the holder 11 can be reduced.

Further, since the bulb 20 is formed by lead-free glass, no lead is released at the time of waste of a used self-ballasted fluorescent lamp 1 and environmental pollution can be prevented.

Furthermore, in the constitution of the first embodiment, the bulb 20 contains an ultraviolet ray reduction material, so that ultraviolet rays can be reduced more surely and the bulb 20 can be manufactured easily.

Further, in the constitution of the first embodiment, the self-ballasted fluorescent lamp 1 is used as a fluorescent lamp. However, since the bulb 20 contains a metal oxide as an ultraviolet ray reduction material and the synthetic-resin holder 11 installed in the neighborhood of the bulb 20 contains a metal oxide, even if the holder 11 exceeds 100° C., the deterioration speed of the holder 11 will not increase suddenly.

Next, a manufacturing example of a fluorescent lamp having the constitution of the first embodiment will be explained.

Self-ballasted fluorescent lamps having the constitution of the first embodiment are manufactured and the ultraviolet ray transmission characteristic thereof is measured.

Table 1 shows a glass composition of this manufacturing example.

TABLE 1

| | Composition |
|---|---|
| Component | ratio (wt-%) |
| SiO₂ | 60-70 |
| Al₂O₃ | 1-5 |
| Li₂O | 0-3 |
| Na₂O | 1-10 |
| K₂O | 1-10 |
| CaO | 0-3 |
| MgO | 0-2 |
| BaO | 4-6 |
| SrO | 0.5-10 |
| B₂O₃ | 0-3 |
| Sb₂O₃ | 0 |
| Fe₂O₃ | 0.05-1 |
| CeO₂ | 0-3 |
| TiO₂ | 0 |
| ZnO | 0-3 |

Namely, this manufacturing example uses lead-free glass bulbs containing, as ultraviolet ray reduction materials, ferric oxide (Fe₂O₃), cerium oxide (CeO₂), and zinc oxide (ZnO) of 0.05 wt-% or more and sodium oxide (Na₂O) of 10 wt-% or less. In the constitution shown in Table 1, CeO₂, TiO₂, and ZnO are 0.05 to 3.0 wt-% in total.

Further, for comparison with this manufacturing example, also for lead-free glass bulbs (Comparative 1) containing no ultraviolet ray reduction materials and lead-glass bulbs (Comparative 2) containing lead oxide, the ultraviolet ray transmission characteristic is measured.

Further, also in Comparative 1, the bulbs contain sodium oxide of 10 wt-% or less of the weight thereof.

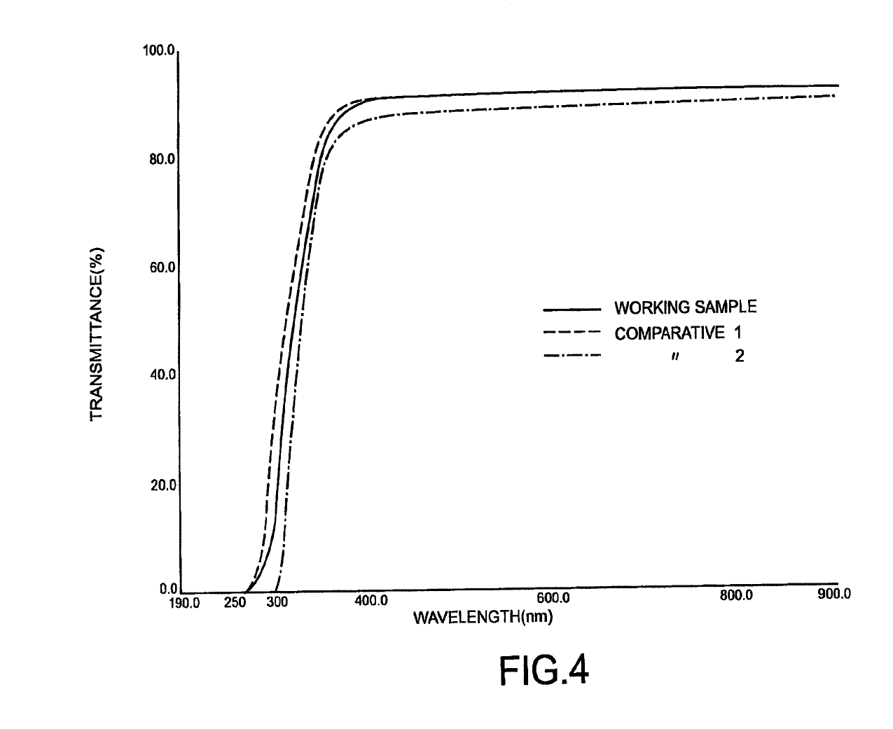

FIG. 4 is a graph showing the ultraviolet ray transmission characteristic relating to this manufacturing example, Comparatives 1 and 2.

As shown in FIG. 4, in the bulbs of this manufacturing example, the ultraviolet ray transmission factor is about 30% at 300 nm, while in the bulbs of Comparative 1, the ultraviolet ray transmission factor is about 48% at 300 nm.

Further, in the visible light range, in the bulbs of this manufacturing example and the bulbs of Comparative 1, the transmission factor is about 90 to 92%, while in the bulbs of Comparative 2, the transmission factor is about 88 to 90%.

Therefore, when bulbs contain, as ultraviolet ray reduction materials, ferric oxide (Fe₂O₃), cerium oxide (CeO₂), and zinc oxide (ZnO) of 0.05 wt-% or more, it is ascertained that the ultraviolet ray transmission factor of bulbs can be reduced to 40% or less at 300 nm or less and the visible light transmission factor is very high.

As a result, it is ascertained that for example, the deterioration of a member arranged around a bulb formed by synthetic resin can be effectively prevented and sufficient brightness can be kept.

Next, a fluorescent lamp of the second embodiment of the present invention will be explained. The explanation of duplicate contents of the first embodiment will be omitted.

A fluorescent lamp having the constitution of the second embodiment is structured so as to form an ultraviolet ray reduction material layer between the inner wall of the bulb and the phosphor. The bulb relating to the invention of the second embodiment contains no ultraviolet ray reduction material, so that the ultraviolet ray transmission factor of the single bulb excluding the ultraviolet ray reduction material layer at 300 nm or less is more than 45%.

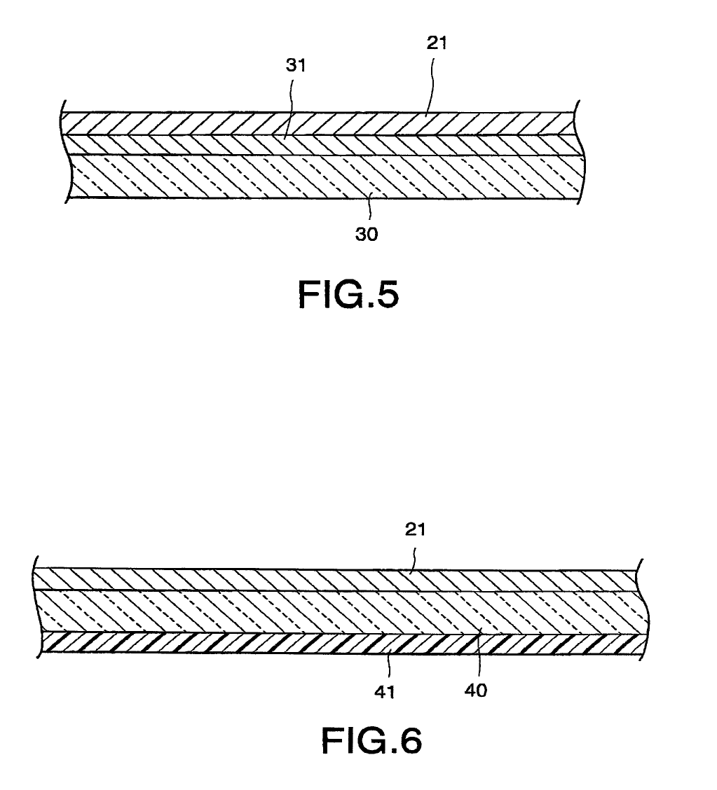

FIG. 5 is an enlarged cross sectional view schematically showing a bulb of the self-ballasted fluorescent lamp 1 having the constitution of the second embodiment.

As shown in FIG. 5, between the inner wall of a glass layer 30 and a phosphor layer 21, as an ultraviolet ray reduction material, for example, an ultraviolet ray reduction material layer 31 for reflecting or absorbing ultraviolet rays is formed, for example, in a thickness of about 1 μm.

The ultraviolet ray reduction material layer 31 is preferably formed from a metallic oxide such as Fe₂O₃, CeO₂, TiO₂, or ZnO in the same way as with the ultraviolet ray reduction material relating to the invention of the first embodiment.

Further, the ultraviolet ray reduction material layer 31 is formed, for example, by adding a binder solution to fine particles of metallic oxide as mentioned above so as to form a suspension and then coating, drying, and calcining it on the inner wall of the glass layer 30. Furthermore, a single crystal film of the aforementioned metallic oxide formed by coating, drying, and calcining a metallic alcoxide solution may be used.

As mentioned above, in the self-ballasted fluorescent lamp 1 having the constitution of the second embodiment, between the inner wall of the glass layer 30 and the phosphor layer 21, the ultraviolet ray reduction material layer 31 for reflecting or absorbing ultraviolet rays is formed, so that a special effect that the ultraviolet ray reduction material layer 31 is formed even after the glass layer 30 is formed in a predetermined shape and the ultraviolet transmission factor of the glass layer 30 is reduced to 40% or less at 300 nm or less can be produced.

Next, the third embodiment of the present invention will be explained.

The third embodiment uses a constitution that a film formed by synthetic resin is provided on the outer wall of a bulb. A bulb relating to the invention of the third embodiment contains no ultraviolet ray reduction material, so that the ultraviolet ray transmission characteristic is the same as that of the second embodiment.

FIG. 6 is an enlarged cross sectional view schematically showing a bulb of the self-ballasted fluorescent lamp 1 having the constitution of the third embodiment.

As shown in FIG. 6, on the outer wall of a glass layer 40, a synthetic-resin tube-shaped PET film 41 with a thickness of about 1 μm is formed.

The film 41 contains a metallic oxide similar to the metal oxide as an ultraviolet reduction material in the constitution of the first embodiment mentioned above. Since the synthetic-resin film 41 contains the aforementioned metallic oxide, ultraviolet rays emitted from the inside of the glass layer 40 can be reduced more.

In this case, synthetic resin has a property of absorption of ultraviolet rays, so that when the synthetic-resin film 41 is formed on the outer wall of the glass layer 40, the film 41 can absorb or reflect ultraviolet rays.

As a synthetic resin for forming the film 41 in the constitution of the third embodiment, for example, one or two or more thermoplastic synthetic resins selected from a group composed of polyethylene terephthalate, polybutylene terephthalate, polypropylene, 4-ethylene fluoride, and polycarbonate can be used.

Further, the film 41 is formed, for example, by a general method such as extrusion molding.

As mentioned above, in the self-ballasted fluorescent lamp 1 having the constitution of the third embodiment, the synthetic-resin film 41 is formed on the outer wall of the glass layer 40, so that even after the glass layer 40 is formed in a predetermined shape, the film 41 can be formed, and the ultraviolet ray transmission factor of the glass layer 40 can be reduced to 40% or less at 300 nm or less, and the cost can be reduced. Furthermore, even in the self-ballasted fluorescent lamp 1 in use, the synthetic-resin film 41 can be formed on the outer wall of the glass layer 40 and the ultraviolet ray transmission of the glass layer 40 of the self-ballasted fluorescent lamp 1 in use can be reduced.

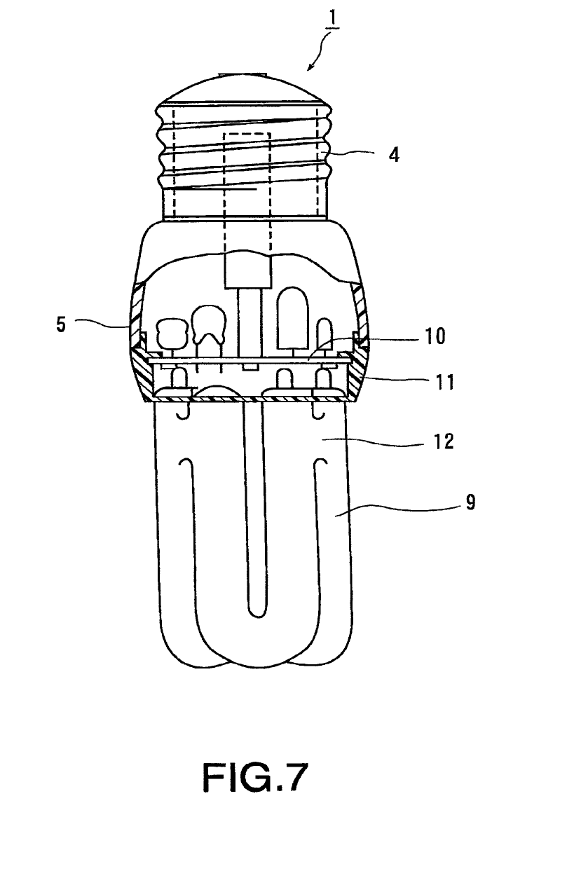

In the constitution of each of the first to third embodiments, the self-ballasted fluorescent lamp with a globe for protecting the bulb 9 provided is explained. However, as shown in FIG. 7 which is a cross sectional view schematically showing an deformation example of the self-ballasted fluorescent lamp of the first embodiment, a constitution having no globe may be used. In this case, when the bulb 9 contains an ultraviolet ray reduction material and an ultraviolet ray reduction material layer is formed on the inner wall or outer wall of the bulb 9, even in such a constitution having no globe, for example, the synthetic-resin member arranged around the bulb 9 can be prevented from deterioration.

Next, a fluorescent lamp having the constitution of the fourth embodiment of the present invention will be explained.

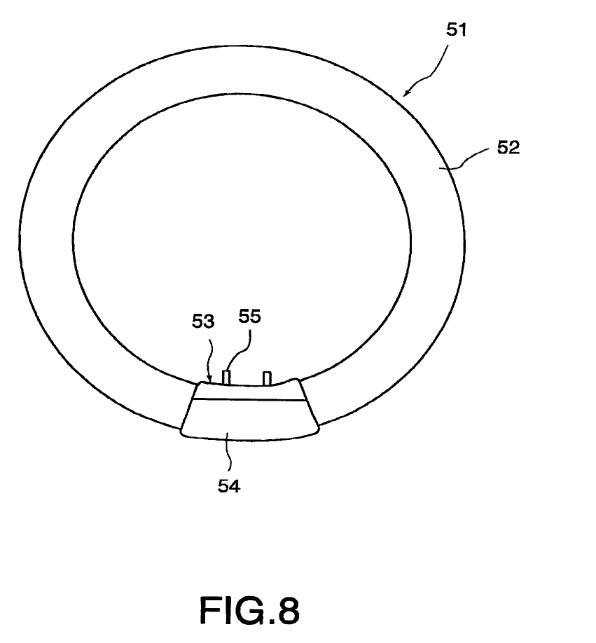

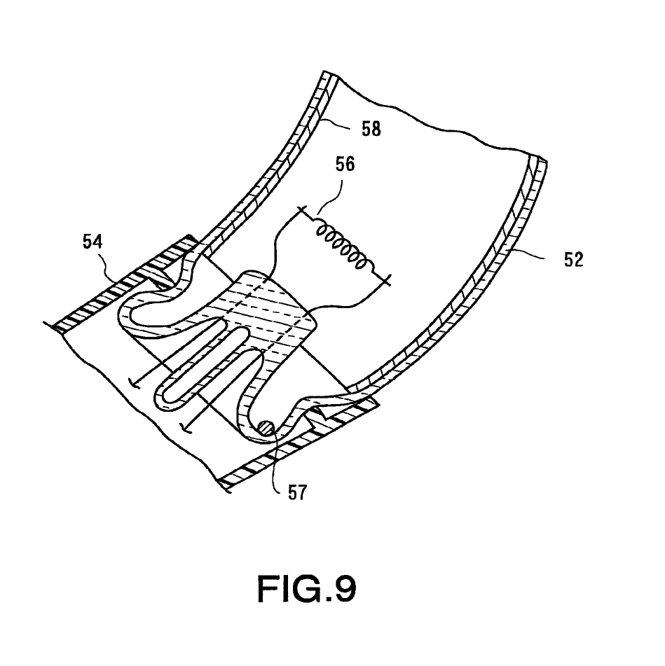

FIG. 8 is a plan view schematically showing a fluorescent lamp having the constitution of the fourth embodiment and FIG. 9 is a cross sectional view schematically showing the electrode part thereof.

As shown in FIGS. 8 and 9, a fluorescent lamp 51 having the constitution of the fourth embodiment has a glass bulb 2 formed in a ring-shape.

Further, at the end of a glass bulb 52, a screw base 53 of a multileg projection type like G10q is provided. The screw base 53 is composed of a screw base plate 54 formed by synthetic resin such as polybutylene terephthalate and a screw base conductor 55 in a pin-shape and a voltage is applied to a discharge electrode 56, which will be explained next, from an external power source not shown in the drawing via the screw base conductor 55.

At a pair ends of the glass bulb 2, filament electrodes 56 for generating discharge in the glass bulb 52 are arranged. On the filament electrodes 56, a thermion emissive material such as barium oxide, potassium oxide, or strontium oxide is coated.

Further, in the glass bulb 52, a fixed amount of mercury is sealed in a form of zinc-mercury alloy particles 57.

Furthermore, on the inner wall of the glass bulb 52, for example, a phosphor layer 58 composed of a three-wavelength phosphor activated by a rare-earth element is formed.

Next, the glass bulb 52 having the constitution of the fourth embodiment will be explained. In this case, the glass bulb 52 having the constitution of the fourth embodiment which is formed in a ring-shape uses glass containing lead-free component practically. The glass bulb 52 contains sodium oxide of 11 wt-% or less and also an iron component of 0.06 wt-% or less of reduced ferric oxide.

Further, the glass bulb 52 contains, in addition to the aforementioned materials, potassium oxide of 1 to 10 wt-% and lithium oxide of 3 wt-% or less. The total amount of sodium oxide, potassium oxide, and lithium oxide is controlled to 5 to 20 wt-%.

Further, the oxidation clarify method is applied to form the glass bulb 52. Therefore, antimony oxide of 0.1 to 0.5 wt-% is contained and also the amount of ferric oxide contained in the glass bulb 52 is larger than the amount of iron oxide.

Furthermore, the ultraviolet ray transmission factor at a thickness of 0.8 mm of the glass bulb 52 is 35% or more at 300 nm.

Next, the lighting operation of the fluorescent lamp 51 having the constitution of the fourth embodiment will be explained.

In this case, the fluorescent lamp 51 having the constitution of the fourth embodiment is a fluorescent lamp having a tube wall load of 0.07 W/cm² or less.

In the constitution of the fourth embodiment, although the content of sodium oxide is 11 wt-% or less, the glass bulb 52 is used, so that the sodium component educed on the inner wall of the glass bulb 52 can be reduced.

Therefore, the reaction of the sodium component with the mercury vapor sealed in the glass bulb 52 can be reduced.

Accordingly, the ultraviolet ray solarization of the glass bulb 52 can be reduced and the visible light transmission factor can be improved. Further, the reduction in mercury vapor due to reaction can be prevented and sufficient brightness can be kept.

Further, since the bulb 52 is formed by glass containing no lead practically, no lead is released at the time of waste of a used fluorescent lamp and environmental pollution can be prevented.

Further, the fluorescent lamp 51 having the constitution of the fourth embodiment has a tube wall load of 0.07 W/cm² or less, so that ultraviolet rays transmitting the glass bulb 52 are comparatively little. Therefore, even when the glass bulb 52 having the constitution of the fourth embodiment is used, the screw base plate 54 and the member arranged around the fluorescent lamp 51 are hardly deteriorated by ultraviolet rays. Ultraviolet rays radiated from mercury vapor are absorbed by the glass bulb 52, so that they do not transmit the glass bulb 52.

Furthermore, the phosphor layer 58 contains a blue series phosphor, so that it can absorb ultraviolet rays in the wavelength range easily transmitting the glass bulb 52 which are generated from another phosphor, that is, a green series phosphor and can suppress ultraviolet rays transmitting the glass bulb 52. As a result, the effect of ultraviolet rays can be reduced more.

Next, a manufacture example 1 of a fluorescent lamp having the constitution of the fourth embodiment will be explained.

A fluorescent lamp having the constitution of the fourth embodiment is manufactured and the brightness after lighting for 100 hours and for 2000 hours is measured.

Next, the measuring conditions will be explained. Table 2 shows the composition and composition ratio of the glass bulb 52 of this manufacture example.

TABLE 2

| | Composition |
|---|---|
| Component | ratio (wt-%) |
| SiO₂ | 71.7 |
| Al₂O₃ | 2.0 |
| Na₂O | 6.4 |
| K₂O | 8.1 |
| Li₂O | 1.4 |
| CaO | 1.9 |
| MgO | 1.0 |
| SrO | 5.3 |
| BaO | 1.5 |
| SO₃ | 0.1 |
| B₂O₃ | 1.9 |
| SbO₃ | 0.4 |
| Fe₂O₃ | 0.03 |
| Rests | 0.7 |

Namely, in the glass bulb of this manufacture example, the content of sodium oxide is 6.4 wt-%, the content of potassium oxide 8.1 wt-%, the content of lithium oxide 1.4 wt-%, the content of antimony oxide 0.4 wt-%, and the content of ferric oxide 0.03 wt-%. Further, in this manufacture example, the total of the content of ferric oxide and the content of iron oxide of reduced ferric oxide is 0.06 wt-% or less.

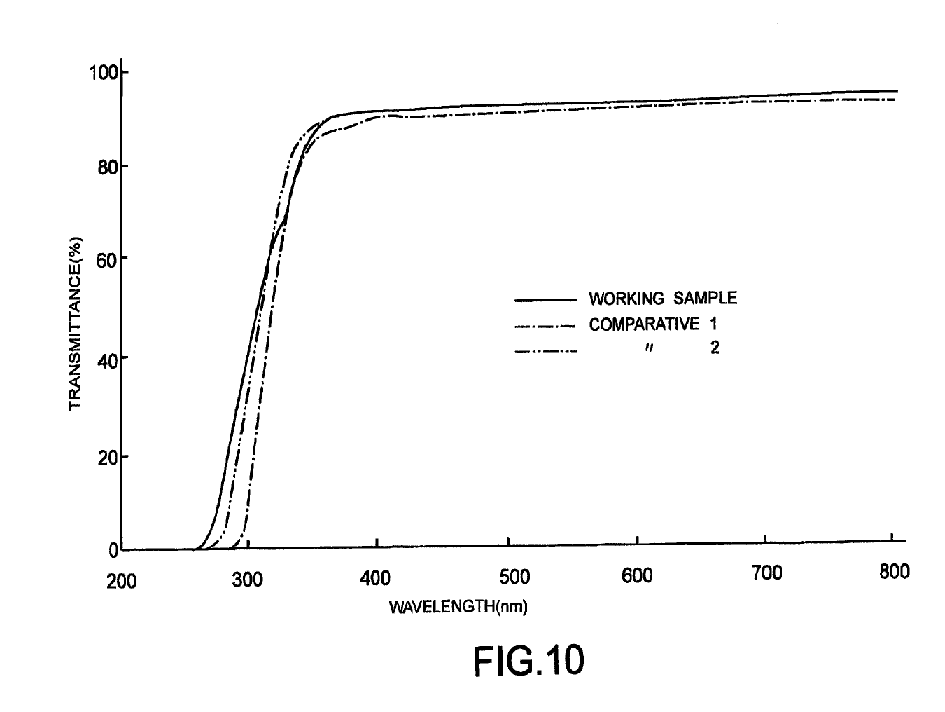

The ultraviolet ray transmission characteristic of the glass bulb of the manufacture example is shown in FIG. 10. In this case, for comparison with glass bulbs used in the manufacture example, also for glass bulbs (Comparative 1) formed by lead glass containing lead oxide and glass bulbs (Comparative 2) formed by conventional soda-lime glass, the transmission characteristic is measured. The thickness of each glass bulb is 0.8 mm.

As shown in FIG. 10, the glass bulbs of the manufacture example have an ultraviolet ray transmission factor of about 45% at 300 nm, while the glass bulbs relating to Comparative 1 have an ultraviolet ray transmission factor of about 10% at 300 nm and the glass bulbs relating to Comparative 2 have an ultraviolet ray transmission factor of about 32% at 300 nm.

Further, for visible light, both of the glass bulbs of the manufacture example and the glass bulbs of Comparative 2 have a transmission factor of about 90 to 92%, while the glass bulbs of Comparative 1 have a transmission factor of about 88 to 90%.

Next, the tube wall load of the fluorescent lamp of the manufacture example will be explained. In this manufacture example, a fluorescent lamp of a ring-shaped 30 W (FCL30/28) type is used. The tube wall load of the manufacture example of this type is measured and 0.062 W/cm² is obtained.

Furthermore, in the manufacture example, as a blue series phosphor, divalant europium activated by dihydric europium and manganese, as a magnesium phosphor and a green series phosphor, lantern phosphate phosphor activated by cerium and terbium, and as a red series phosphor, yttrium oxide phosphor activated by trivalent europium are used. The concrete amount of the phosphors are dihydric europium and manganese and magnesium phosphor at 24 wt-%, and lantern phosphate phosphor activated by cerium and terbium at 40 wt-%, and yttrium oxide phosphor activated by trivalent europium at 36 wt-%.

The brightness of the manufacture example having the aforementioned phosphors after lighting for 100 hours and for 2000 hours is measured.

In this case, for comparison with the fluorescent lamp of the manufacture example, the brightness of the fluorescent lamp of Comparative 2 is also measured. The fluorescent lamp of Comparative 2 has the same constitution as that of the fluorescent lamp of the manufacture example except the composition of glass bulbs.

The measured results are indicated below.

After lighting for 100 hours, the brightness of the fluorescent lamp relating to the manufacture example is higher than that of the fluorescent lamp relating to Comparative 2 by 3%.

Further, after lighting for 2000 hours, the brightness of the fluorescent lamp relating to the manufacture example is higher than that of the fluorescent lamp relating to Comparative 2 by 5%.

Furthermore, the ultraviolet ray transmission amount from the fluorescent lamp relating to the manufacture example can be suppressed within the allowable range and no problem of color deterioration is caused.

Next, the constitution of the fifth embodiment will be explained. The explanation of the duplicate parts of the constitution of the fourth embodiment will be omitted. In the constitution of the fifth embodiment, the blue series phosphor layer is formed between the glass layer and the green series phosphor and red series phosphor layers.

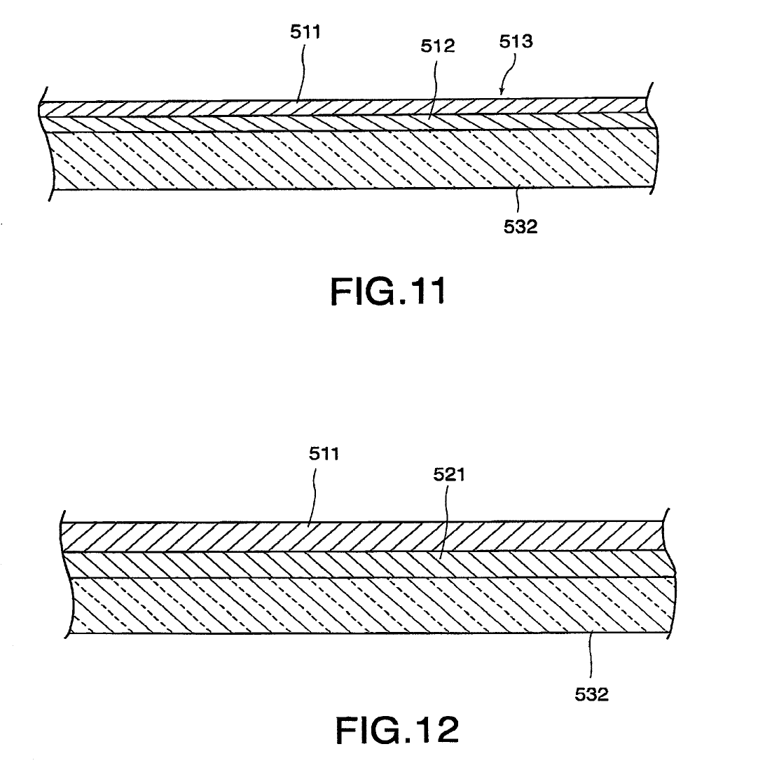

FIG. 11 is a cross sectional view schematically showing the enlarged glass bulb 52 of the fluorescent lamp 51 having the constitution of the fifth embodiment.

As shown in FIG. 11, between a glass layer 532 and a green and red series phosphor layer 511 formed by mixing a green series phosphor and a red series phosphor, a blue series phosphor layer 512 is formed. In this case, the blue series phosphor layer 512 cannot absorb ultraviolet rays emitted from mercury vapor because the ultraviolet rays emitted from mercury vapor are absorbed by the green and red series phosphor layer 511, thus no light is almost emitted from the ultraviolet rays emitted from mercury vapor.

In the constitution of the fifth embodiment, between the glass layer 532 and the green and red series phosphor layer 511, the blue series phosphor layer 512 is formed, so that light at a low color temperature can be produced. Namely, as mentioned above, firstly, the green and red series phosphor layer 511 emits light by ultraviolet rays radiated from mercury vapor. At the time of light emission, the green and red series phosphor layer 511 emits ultraviolet rays. The blue series phosphor layer 512 absorbs the ultraviolet rays and emits light. However, the light emitted from the blue series phosphor layer 512 is weaker than the light emitted by ultraviolet rays radiated from mercury vapor, so that in the light emitted from phosphor layer 513, green series light and red series light are much included. Therefore, light at a low color temperature can be produced.

Ultraviolet rays emitted from the green and red series phosphor layer 511 can be suppressed more.

Next, the constitution of the sixth embodiment of the present invention will be explained.

In the constitution of the sixth embodiment, between the glass layer 532 and the phosphor layer 58, a protective film containing a metallic oxide having a function (protection function) for suppressing reaction of the sodium component in glass with mercury vapor and an ultraviolet ray absorption function for absorbing ultraviolet rays is formed.

FIG. 12 is a cross sectional view schematically showing the enlarged glass bulb 52 of the fluorescent lamp 51 having the constitution of the sixth embodiment.

As shown in FIG. 12, between the glass layer 532 and the phosphor layer 58, a protective film 521 containing a metallic oxide such as titanium oxide having both of the protection function and ultraviolet ray absorption function is formed. In this case, the protective film 521 of the fluorescent lamp having the constitution of the sixth embodiment contains no metallic oxide having only the protection function, for example, aluminum oxide

Further, the protective film 521 may be formed by mixing two or more metallic oxides having both of the protection function and ultraviolet ray absorption function.

Further, the particle diameter of a metallic oxide is preferably about 0.1 μm or less. The reason that the aforementioned numerical value is preferable is that when the particle diameter is more than the value, the contact of the sodium component educed on the glass layer 532 with mercury vapor cannot be prevented effectively. The particle diameter of a metallic oxide is more preferably about 0.02 to 0.04 μm.

The protective film 521 is formed, for example, by adding a binder solution to a metallic oxide to produce a suspension and then coating, drying, and calcining it on the inner wall of the glass layer 532.

The thickness of the protective film 521 is preferably about 0.1 to 1.0 μm. The reason that the range is preferable is that when the thickness is beyond the range, the protective film 521 also absorbs visible light emitted from the phosphor layer 58 and the brightness is reduced and when the thickness is below the range, the protective film 521 cannot suppress ultraviolet rays transmitting the glass layer 532 effectively.

As mentioned above, in the constitution of the sixth embodiment, the protective film 521 including a metallic oxide having both of the protection function and the ultraviolet ray absorption function is formed between the glass layer 532 and the phosphor layer 58, so that the protective film 521 can suppress ultraviolet rays transmitting the glass layer 532 without reducing the light flux and reduce the effect by ultraviolet rays.

Since the protective film 521 has both functions, it can be formed by one kind of metallic oxide, thus the protective film 521 can be formed thin.

Next, a manufacture example of a fluorescent lamp having the constitution of the sixth embodiment will be explained.

A fluorescent lamp having the constitution of the sixth embodiment is manufactured and the ultraviolet ray transmission amount thereof and all light flux are measured.

As a fluorescent lamp of the manufacture example, the same fluorescent lamp as that of the manufacture example of the constitution of the fourth embodiment mentioned above is used.

Further, in the constitution of the sixth embodiment, four kinds of fluorescent lamps A to D different in the composition metallic oxide and thickness of the protective film are manufactured and measured.

Furthermore, for comparison of the four kinds of fluorescent lamps A to D of the manufacture example, the comparative having a protective film using aluminum oxide as a metallic oxide is also measured. The fluorescent lamps of the comparative have the same constitution as that of the fluorescent lamps of the manufacture example except the composition of the protective film.

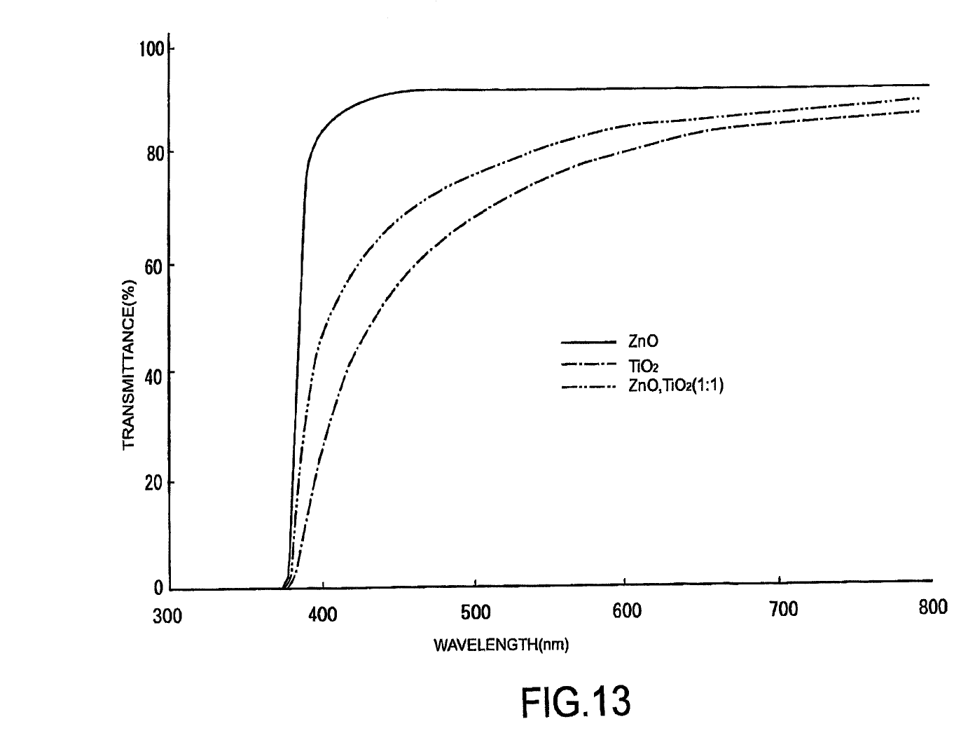

The measured results are indicated below. Table 3 shows measured results of the fluorescent lamps A to D of the manufacture example and the fluorescent lamps of the comparative having the constitution of the sixth embodiment. FIG. 13 is a graph showing the ultraviolet ray transmission characteristic of the glass bulbs of the fluorescent lamps A to D of the manufacture example. Table 3 shows variations of the ultraviolet ray transmission amount of the fluorescent lamps relating the manufacture example on the basis of the ultraviolet ray transmission amount of the fluorescent lamps of the comparative.

TABLE 3

| | | Film | Ultraviolet | Whole |
|---|---|---|---|---|
| | Metallic | thickness | transmission | light flux |
| | oxide | (μm) | amount | (lm) |
| Example A | ZnO | 0.1 | Reduced | 2000 |
| Example B | TiO₂ | 0.1 | Reduced | 1990 |
| Example C | CeO₂ | 0.1 | Reduced | 1990 |
| Example D | ZnO | 1.0 | Reduced | 2000 |
| Comparative | Al₂O₃ | 1.0 | | 2000 |

As shown in Table 3 and FIG. 13, it is ascertained that the ultraviolet ray amount transmitting the glass bulbs of all the four kinds of fluorescent lamps A to D of the manufacture example is smaller than that of the fluorescent lamps of the comparative.

Further, it is ascertained that in the fluorescent lamps A to D of the manufacture example, the all light flux is almost 2000 (lm) and it is equal to that of the fluorescent lamps of the comparative.

As shown in FIG. 13, it is ascertained that even in the protective film having both of zinc oxide and titanium oxide, the amount of ultraviolet rays transmitting the glass bulb is smaller than that of the fluorescent lamps of the comparative.

Next, the constitution of the seventh embodiment of the present invention will be explained.

In the constitution of the seventh embodiment, between the glass bulb 52 and the phosphor layer 58, a protective film containing a first metallic oxide having the protection function and a second metallic oxide having the ultraviolet ray absorption function is formed.

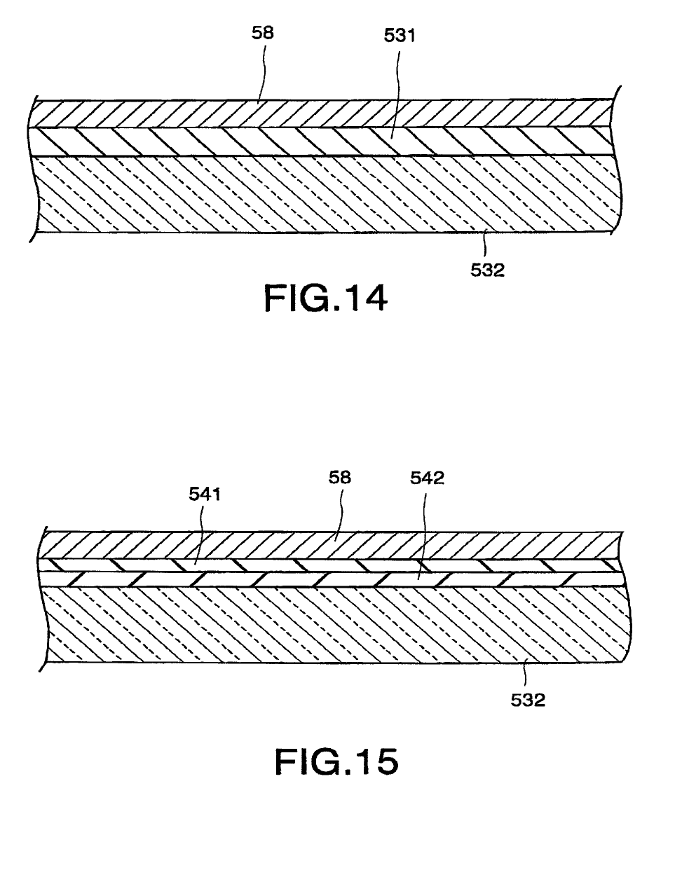

FIG. 14 is a cross sectional view schematically showing the enlarged glass bulb 52 of the fluorescent lamp 51 having the constitution of the seventh embodiment. As shown in FIG. 14, between the glass layer 532 and the phosphor layer 58, for example, a protective film 31 containing a first metallic oxide having the protection function such as aluminum oxide and a second metallic oxide having the ultraviolet ray absorption function such as zinc oxide is formed.

In this case, in the constitution of the seventh embodiment, a single-layer protective film that the first metallic oxide and the second metallic oxide are mixed is formed.

The content of the second metallic oxide is preferably 10 to 50 wt-% of the first metallic oxide. The reason that the range is preferable is that when the content is beyond the range, the brightness lowers and when the content is below the range, ultraviolet rays cannot be absorbed effectively, thus ultraviolet rays transmitting the glass bulb 2 cannot be suppressed effectively.

As mentioned above, in the constitution of the seventh embodiment, between the glass layer 532 and the phosphor layer 58, the protective film 31 containing the first metallic oxide having the protection function and the second metallic oxide having the ultraviolet ray absorption function is formed, so that the protective film 31 can suppress ultraviolet rays transmitting the glass bulb 2 without reducing the light flux and reduce the effect by ultraviolet rays. Further, the cost can be reduced.

Next, a manufacture example of a fluorescent lamp having the constitution of the seventh embodiment will be explained.

A fluorescent lamp relating to the invention of the seventh embodiment is manufactured and the ultraviolet ray transmission amount thereof and all light flux are measured.

As a fluorescent lamp of the manufacture example, the same fluorescent lamp as that of the manufacture example of the constitution of the fourth embodiment mentioned above is used.

Further, five kinds of fluorescent lamps E to I different in the kind of second metallic oxide and the weight ratio to aluminum oxide as a first metallic oxide are manufactured and measured.

Furthermore, for comparison of the five kinds of fluorescent lamps of the manufacture example, the fluorescent lamps having no protective film (comparative) are also measured. The fluorescent lamps of the comparative have the same constitution as that of the fluorescent lamps of the manufacture example except that they have no protective film.

The measured results are indicated below.

Table 4 shows measured results of the fluorescent lamps E to I of the manufacture example and the fluorescent lamps of the comparative having the constitution of the seventh embodiment. For the ultraviolet ray transmission amount of the fluorescent lamps E to I of the manufacture example, variations thereof on the basis of the ultraviolet ray transmission amount of the fluorescent lamps of the comparative are shown.

TABLE 4

| | | Weight | | |
|---|---|---|---|---|
| | | ratio to | Ultraviolet | Whole |
| | Metallic | aluminum | transmission | light flux |
| | oxide | oxide | amount | (lm) |
| Example E | ZnO | 0.1 | Reduced | 2000 |
| Example F | ZnO | 0.1 | Reduced | 2000 |
| Example G | ZnO | 0.1 | Reduced | 1990 |
| Example H | TiO₂ | 1.0 | Reduced | 1990 |
| Example I | CeO₂ | 1.0 | Reduced | 1990 |
| Comparative | — | 1.0 | | 2000 |

As shown in Table 4, it is ascertained that the ultraviolet ray amount transmitting the glass bulbs of all the five kinds of fluorescent lamps E to I of the manufacture example is smaller than that of the fluorescent lamps of the comparative.

Further, it is ascertained that in the fluorescent lamps E to I of the manufacture example, the all light flux is almost 2000 (lm) and it is equal to that of the fluorescent lamps of the comparative.

Next, the constitution of the eighth embodiment of the present invention will be explained.

In the constitution of the eighth embodiment, between the glass layer 532 and the phosphor layer 58, a two-layer protective film composed of a first protective film containing a first metallic oxide having the protection function and a second protective film containing a second metallic oxide having the ultraviolet ray absorption function is formed.

FIG. 15 is a cross sectional view schematically showing the enlarged glass bulb 2 of the fluorescent lamp 1 having the constitution of the eighth embodiment.

As shown in FIG. 15, between the glass layer 532 and the phosphor layer 58, a two-layer protective film composed of a first protective film 541 containing a first metallic oxide having the protection function such as aluminum oxide and a second protective film 542 containing a second metallic oxide having the ultraviolet ray absorption function such as zinc oxide is formed.

In the constitution of the eighth embodiment, the second protective film 542 is formed between the first protective film 541 and the glass layer 532.

Further, when zinc oxide is to be used as a second metallic oxide, the second protective film 542 is preferably about 0.3 μm or less in thickness. The reason is that zinc oxide is vitrified at high temperature, so that the second protective film 542 is prevented from easily tearing off.

As mentioned above, in the constitution of the eighth embodiment, between the glass layer 532 and the phosphor layer 58, the two-layer protective layer composed of the first protective film 541 containing the first metallic oxide having the protection function and the second protective film 542 containing the second metallic oxide having the ultraviolet ray absorption function is formed, so that the protective film can surely suppress reaction of the sodium component educed on the inner wall of the glass layer 532 with mercury vapor, surely suppress ultraviolet rays transmitting the glass layer 532, and reduce the effect by ultraviolet rays.

Next, a manufacture example of a fluorescent lamp having the constitution of the eighth embodiment will be explained.

A fluorescent lamp having the constitution of the eighth embodiment is manufactured and the ultraviolet ray transmission amount thereof, all light flux, and appearance are measured.

As a fluorescent lamp of the manufacture example, the same fluorescent lamp as that of the manufacture example of the constitution of the fourth embodiment mentioned above is used.

Further, in the constitution of the eighth embodiment, the metallic oxides of the first and second protective films are the same and two kinds of fluorescent lamps J and K different in film thickness of the second protective film are manufactured and measured.

Furthermore, for comparison of the two kinds of fluorescent lamps J and K of the manufacture example, the fluorescent lamps having no protective film (comparative) are also measured. The fluorescent lamps of the comparative have the same constitution as that of the fluorescent lamps of the manufacture example except that they have no protective film.

The measured results are indicated below.

Table 5 shows measured results of the fluorescent lamps J and K of the manufacture example and the fluorescent lamps of the comparative having the constitution of the eighth embodiment. For the ultraviolet ray transmission amount of the fluorescent lamps J and K of the manufacture example, variations thereof on the basis of the ultraviolet ray transmission amount of the fluorescent lamps of the comparative are shown.

TABLE 5

| | | | | Whole | |
|---|---|---|---|---|---|
| | | Film | Ultraviolet | light | |
| | Metallic | thickness | transmission | flux | |
| | oxide | (μm) | amount | (lm) | Appearance |
| Example J | ZnO | 0.1 | Reduced | 2000 | ◯ |
| Example K | ZnO | 0.5 | Reduced | 1980 | Δ |
| Comparative | | | | 2000 | ◯ |

As shown in Table 5, it is ascertained that the ultraviolet ray amount transmitting the glass bulbs of all the five fluorescent lamps J and K of the manufacture example is smaller than that of the fluorescent lamps of the comparative.

Further, it is ascertained that in the fluorescent lamps J and K of the manufacture example, the all light flux is almost 2000 (lm) and it is equal to that of the fluorescent lamps of the comparative.

Furthermore, the fluorescent lamps J of the manufacture example are superior to the fluorescent lamps K of the manufacture example in appearance.

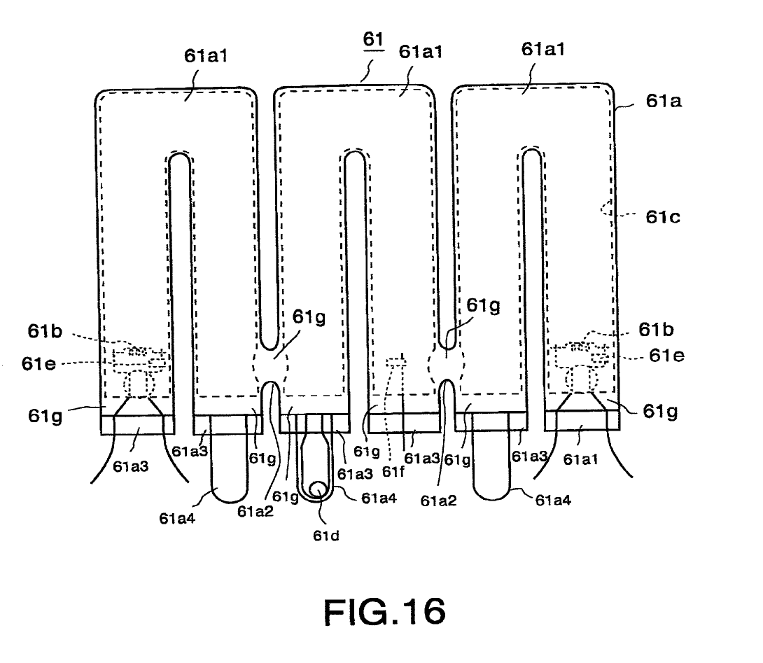

Next, a fluorescent lamp having the constitution of the ninth embodiment of the present invention will be explained by referring to FIG. 16.

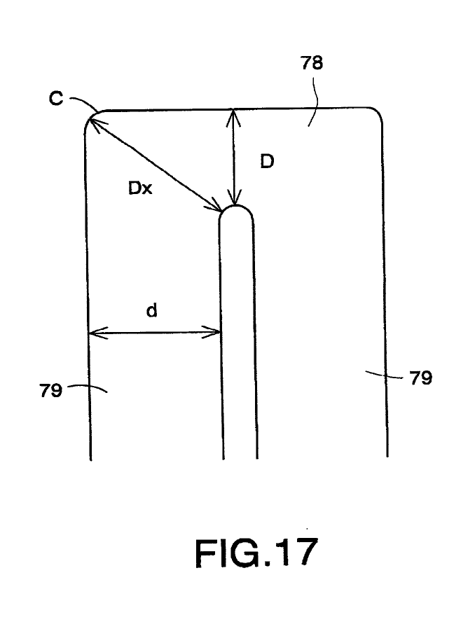

FIG. 16 is a development elevation of a developed bulb of a self-ballasted fluorescent lamp having the constitution of the ninth embodiment and FIG. 17 is an enlarged view showing the bending part of one U-shaped tube of the bulb.

A self-ballasted fluorescent lamp having the constitution of the ninth embodiment has an almost same constitution as that of the fluorescent lamp having the constitution of the first embodiment shown in FIG. 1 and the bulb particularly has the constitution shown in FIG. 16.

Namely, as shown in FIG. 16, a bulb 61a forms a discharge line that three U-shaped glass tubes 61a1 with an outer diameter of 10 mm are connected and bent by two connection tubes 61a2 and in the same way as with the self-ballasted fluorescent lamp having the constitution of the first embodiment shown in FIG. 1, the three U-shaped glass tubes 61a1 are arranged compactly so as to be positioned almost at each side of a regular triangle. The composition of glass will be described later. Each U-shaped glass tube 61a1 has pinch seal parts 61a3 formed at both ends thereof and one exhaust tube 61a4 is projected outside from one pinch seal part 61a3. To facilitate forming of the pinch seal parts 61a3, the protective film at the pinch seal part forming part and in the neighborhood thereof and a phosphor layer 61c on the inner surface of each of the U-shaped glass tubes 61a1 are removed. Narrow tubes 61a4 are interconnected inside the bulb 61a. For convenience, only the central exhaust tube is shown in a cross sectional view and the inside thereof is shown. The exhaust tubes 61a4 are used to exhaust inside the bulb 61, to store main amalgam 61d, and to seal rare gas. The connection tubes 61a2 are formed by the blow-off method and at the concerned part, the protective film and the phosphor layer 61c are removed at the time of blow-off.

Electrodes 61b are composed of filament electrodes. The electrodes 61b are formed in a triple coil structure composed of a tungsten wire and a thermion emissive material composed of an alkaline earth metal is coated on the tertiary coil.

The protective film is a thin film composed of fine particles of α type Al₂O₃.

The phosphor layer 61c is composed of a three-wavelength luminous phosphor and formed with a thickness of 10 to 30 μm above the protective film, that is, on the inner surface side.

The U-shaped tubes mentioned above, as shown in FIG. 17, assuming the outer diameter of a linear tube part 79 as d and the outer diameter of a bending part 78 in the orthogonal direction to the diameter direction of the linear tube part 79 as D, has a relationship of 0.8d≦D<d and assuming the outer diameter at the corner of the bending part 78 in a slant direction of about 45-degree angle as Dx, has a relationship of 1.2d≦Dx<1.5d. The outer diameter d of the linear tube part 9 is preferably 11 mm and the outer diameter of the bending part 78 is preferably 8.5 mm.

The phosphor layer is formed with a film thickness of 12 to 15 mm at the bending part 78 as a bent part and with a film thickness of 20 to 25 mm at the linear tube parts 79 and 79 and the film thickness at the bending part 78 is minimum. This is a film thickness difference caused at the time of coating and drying of the phosphor in a slurry state. However, the difference at the bending part 78 with a minimum film thickness is 10 μm or more, so that it is sufficient for the ultraviolet ray absorption function and even if lead-free glass is used, it is not affected by ultraviolet rays.

When the ultraviolet ray transmission amount of the fluorescent lamps of the manufacture example and the fluorescent lamps of the comparative having the constitution of the ninth embodiment is measured, the ultraviolet ray transmission amount of the fluorescent lamps of the manufacture example at a wavelength of 300 nm or less is a value (less than 0.0001 W/1000 lm) affecting an article to be emitted little, while that of the fluorescent lamps of the comparative is more than 0.0001 W/1000 lm.

The main amalgam 61d is stored in the exhaust tubes 61a4 of the bulb 61a. The main amalgam 61d is composed of Bi—In—Hg and sealed in the bulb 61a so as to leave one particle with a diameter of about 2.0 mm in each exhaust tube 61a4.

Auxiliary amalgam 61e is composed of In, plated on a stainless steel substrate, and welds the stainless steel substrate to an internal leading-in wire for supporting each electrode 61b. Auxiliary amalgam 61f has basically the same constitution as that of 1e and is welded to a leading-in wire passing through each pinch seal part 61a3 of the U-shaped glass tubes 61a1 at the intermediate position and supported.

A plurality of window parts 61g are formed in the neighborhood of the pinch seal parts 61a3 and in the neighborhood of the connection tubes 61a2. At the window parts 61g, the glass is exposed directly into the discharge space.

The lighting circuit means 2, although the detailed circuit constitution is omitted, is composed mainly of a half-bridge type invertor and energizes and lights the fluorescent lamp 1. The high frequency output terminal is connected to the fluorescent lamp 1 as required.

According to the constitution of the ninth embodiment, self-ballasted fluorescent lamps whose bulbs have the composition shown in Table 6 below are manufactured (Manufacture Example 1).

TABLE 6

| | Composition |
|---|---|
| Component | ratio (wt-%) |
| SiO₂ | 69 |
| Al₂O₃ | 2.0 |
| Li₂O | 1.5 |
| Na₂O | 7.5 |
| K₂O | 4.7 |
| CaO | 3.58 |
| MgO | 2.2 |
| SrO | 5.8 |
| BaO | 3.0 |

In the composition constitution, specific components have the following relationship.

SrO/BaO [symbol] 1.93

(MgO+BaO)/SrO [symbol] 0.90

Next, the evaluation results of glass of Manufacture Example 1 are shown in Table 7 below together with those of the comparative.

Namely, fluorescent lamps of the comparative (#s 2 to 12) different in BaO, SrO/BaO, and (MgO+BaO)/SrO are manufactured and evaluation results of the start-up of brightness are shown in the next table together with those of Manufacture Example 1. In the evaluation test, for fluorescent lamps which are lit for one hour and then conditioned at normal temperature for more than a whole day and night in the off state, the start-up of brightness for ten seconds after lighting is evaluated. The criteria are as shown below by evaluation of the startup level compared with lead glass bulbs.

⊚: Bright by more than 40%

◯: Bright by more than 20%

Δ: Bright by more than 5%

▴: Equivalent brightness

TABLE 7

| | BaO(wt-%) | SrO/BaO | (MgO + BaO)/SrO | Evaluation |
|---|---|---|---|---|
| Example 1 | 0.5-7 | 1.5< | 1 | ⊚ |
| Example 2 | 0.5> | 1.5< | 1 | Δ |
| Example 3 | 7< | 1.5< | 1 | Δ |
| Example 4 | 0.5-7 | 1.5> | 1 | ◯ |
| Example 5 | 0.5-7 | 1.5> | 1< | ◯ |
| Example 6 | 0.5-7 | 1.5< | 1< | ◯ |
| Example 7 | 0.5> | 1.5> | 1 | Δ |
| Example 8 | 0.5> | 1.5> | 1< | ▴ |
| Example 9 | 7< | 1.5< | 1< | Δ |
| Example 10 | 7< | 1.5> | 1< | ▴ |
| Example 11 | 7< | 1.5> | 1 | Δ |
| Example 12 | 0.5> | 1.5< | 1< | Δ |

Table 7 shows that according to the constitution of the ninth embodiment of the present invention, glass constituting a bulb contains lead-free component practically, so that environmental pollution can be prevented and by controlling the composition ratio of BaO, SrO, and MgO within a predetermined range, the startup of brightness is extremely improved compared with the comparative.

Here, the inventors assume one model as a mechanism of affecting the startup of brightness of a fluorescent lamp by adsorption and breakaway of mercury. Namely, the content thereof is that the model, to make the startup of brightness satisfactory, requires suitable electrostatic attraction force between mercury and a substance in contact with it. More in detail, when the electrostatic attraction force between them is excessively large, mercury is eternally kept taken in the contact interface and not diffused into the discharge space, thus the startup of brightness gets worse. When the electrostatic attraction force between them is excessively small inversely, most of mercury of the bulb moves to the amalgam during lights-out. If this occurs, the startup of brightness depends on supply from mercury centralized on one point of amalgam. In this state, as mentioned above, the startup of brightness is bad. On the other hand, when the electrostatic attraction force between them is suitable, mercury is adsorbed at every position of the bulb and when the fluorescent lamp is lit, mercury makes a breakaway from every trapped position, participates in the startup of brightness, and makes it satisfactory.

In the aforementioned model, the inventors take up glass as a material for trapping mercury. In a fluorescent lamp, the inner surface of the bulb composed of glass is almost covered with a protective film and a phosphor layer, though at the seal end and the junction formed at the bent part of the discharge line, the glass is exposed in the discharge space. It is ascertained that when the exposed parts of the glass adsorb mercury when the fluorescent lamp is off and mercury makes a breakaway from the exposed parts simultaneously with lighting and diffuses in the bulb, mercury participates in discharge and contributes to the startup of brightness.

In the aforementioned embodiment, since the bulb is composed of soft glass having the aforementioned predetermined composition, the glass has a suitable charging tendency (electronegativity) and suitable mercury adsorptivity is given to the window part through which the glass is exposed in the discharge space. Therefore, mercury is adsorbed to the window part of the bulb when the fluorescent lamp is off. The window part of the bulb may use the seal part or for example, a part formed at the connection of the two U-shaped glass tubes and the connection tube, so that no special structure is required and it may be properly dispersed in the longitudinal direction of the bulb.

When the fluorescent lamp is lit, mercury adsorbed at the window part of the bulb makes a breakaway all at once and diffuses in the bulb. Therefore, the startup of brightness at an extremely early stage of lighting, that is, within about 10 seconds is accelerated.

Next, the manufacture examples 2 to 4 of fluorescent lamps having the constitution of the ninth embodiment will be explained.

According to the constitution of the ninth embodiment, as shown in Table 8, fluorescent lamps 2 to 4 different in the content of Fe₂O₃ within a predetermined range are manufactured and the all light flux in the early stage of life thereof is measured and compared with the comparatives 12 and 13 using conventional barium silicate glass and lead glass. The composition component amount is indicated by wt-% and for reference, the thermal coefficient of expansion α (10⁻⁷/° C.) and the operating temperature Ts (° C.) are indicated. Furthermore, the relative all light flux is set to 100% in the comparative 14.

TABLE 8

| Com- | Example | Example | Example | Comparative | Comparative |
|---|---|---|---|---|---|
| ponent | 2 | 3 | 4 | 12 | 13 |
| SiO₂ | 69% | 69% | 70% | 70% | 56% |
| Al₂O₃ | 2.0% | 2.0% | 1.9% | 1.9% | 1.2% |
| Li₂O | 1.5% | 1.5% | 1.4% | 1.4% | — |
| Na₂O | 7.8% | 7.8% | 6.4% | 6.4% | 5.1% |
| K₂O | 4.7% | 4.7% | 8.1% | 8.1% | 7.7% |
| CaO | 3.8% | 3.8% | 1.9% | 1.9% | 0.1% |
| MgO | 2.2% | 2.2% | 1.0% | 1.0% | — |
| SrO | 5.8% | 5.8% | 5.4% | 5.4% | — |
| BaO | 3.0% | 3.0% | 1.5% | 1.5% | — |
| Fe₂O₃ | 0.03% | 0.02% | 0.03% | 0.04% | — |
| PbO | — | — | — | — | 29% |
| α | 95 | 95 | 94 | 94 | 92 |
| Ts | 676 | 675 | 676 | 675 | 620 |
| Relative | 102 | 103 | 101 | 100 | 100 |
| whole | | | | | |
| light | | | | | |
| flux | | | | | |

Table 8 shows that in the manufacture examples 2 to 4, when the composition ratio of Fe₂O₃ is set within the predetermined range, the relative all light flux is improved compared with the comparatives 12 and 13. Although not shown in the drawing, they have the operation effect of the manufacture example 1.

The present invention is not limited to the aforementioned constitution and the structure, material, and arrangement of each member can be changed within a range which is not deviated from the objects of the present invention. For example, in the constitution of the first to third embodiments, the use of a metal oxide and synthetic resin as an ultraviolet ray reduction material is explained. However, other materials for reducing the ultraviolet ray transmission factor of a bulb to 40% or less at 300 nm or less may be used.

Further, in the constitution of the first to third embodiments, only a case that a metal oxide is filled in the bulb, only a case that a metal oxide layer is provided between the inner wall of the glass layer and the phosphor layer, and only a case that a film is provided on the outer wall of the glass layer are explained. However, they may be combined.

Further, in the constitution of the first to third embodiments, a metal oxide is contained in the holder. However, it may not be contained.

Furthermore, in the constitution of the first to third embodiments, the use of a self-ballasted fluorescent lamp as a fluorescent lamp is explained. However, any other fluorescent lamps for generating ultraviolet rays may be used.

Further, in the constitution of the second embodiment, the use of a metal oxidelic layer on the inner and outer walls of the glass layer is explained. However, a metal oxidelic layer may be provided on the outer wall of the glass layer.

Further, in the constitution of the third embodiment, a film is formed by synthetic resin. However, a synthetic resin layer may be formed by coating synthetic resin on the outer wall of the glass layer 40.

Further, in the constitution of the sixth to eighth embodiments, a phosphor formed by mixing a blue series phosphor, a green series phosphor, and a red series phosphor is used. However, like the second embodiment, a phosphor divided into a blue series phosphor and a green series phosphor may be used.

Further, in the constitution of the sixth to eighth embodiments, a fluorescent lamp having a tube wall load of 0.07 W/cm² or less is used. However, the protective film absorbs ultraviolet rays, so that the present invention may be applied to a fluorescent lamp whose tube wall load is more than the above value.

In the constitution of each of the aforementioned embodiments of the present invention, a self-ballasted fluorescent lamp is used for explanation. However, the present invention is not limited to it and it may be applied to not only a linear tube or ring-shaped fluorescent lamp but also a compact fluorescent lamp.

As described above, the present invention can provide an extremely preferable fluorescent lamp using lead-free glass containing lead-free component practically, a self-ballasted fluorescent lamp, and a lighting apparatus.

While there have been illustrated and described what are at present considered to be preferred embodiments of the present invention, it will be understood by those skilled in the art that various changes and modifications may be made, and equivalents may be substituted for elements thereof without departing from the true scope of the present invention, In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

The foregoing description and the drawings are regarded by the applicant as including a variety of individually inventive concepts, some of which may lie partially or wholly outside the scope of some or all of the following claims. The fact that the applicant has chosen at the time of filing of the present application to restrict the claimed scope of protection in accordance with the following claims is not to be taken as a disclaimer or alternative inventive concepts that are included in the contents of the application and could be defined by claims differing in scope from the following claims, which different claims may be adopted subsequently during prosecution, for example, for the purposes of a divisional application.

What is claimed is:

1. A fluorescent lamp having a glass bulb containing lead-free component practically, containing sodium oxide of 11 wt-% or less, and having au ultraviolet ray transmission factor of 40% or less at a wavelength of 300 nm or less, mercury and rare gas sealed in said glass bulb, a pair of discharge electrodes for causing discharge in said glass bulb, and a phosphor layer formed on an inner wall of said glass bulb, wherein said fluorescent lamp lights when a tube wall load is 0.05 W/cm² or more.

2. A fluorescent lamp according to claim 1, wherein said glass bulb contains an ultraviolet ray reduction material composed of a metallic oxide of 0.05 wt-% or more.

3. A fluorescent lamp according to claim 2, wherein said ultraviolet ray reduction material is composed of ferric oxide, cerium oxide, titanium oxide, or zinc oxide or a mixture combining at least two kinds of said materials.

4. A fluorescent lamp according to claim 1, wherein said lamp lights at a tube wall load of more than 0.07 W/cm².

5. A fluorescent lamp according to claim 1, wherein said lamp lights at a tube wall load of 0.1 W/cm² or more.

6. A fluorescent lamp according to claim 1, wherein a tube diameter of said glass bulb is 18 mm or less and a thickness is 0.5 to 1.5 mm.

7. A self-ballasted fluorescent lamp having a fluorescent lamp stated in claim 6 wherein said glass bulb has a U-shaped bent part, a cover for supporting said fluorescent lamp, a screw base attached to said cover, and a lighting circuit electrically connected to said screw base and housed in said cover for lighting said fluorescent lamp.

8. A self-ballasted fluorescent lamp according to claim 7, wherein said cover is formed by synthetic resin and contains a metallic oxide of 5.0 wt-% or more for absorbing ultraviolet rays.

9. A fluorescent lamp having a glass bulb containing lead-free component practically, containing sodium oxide of 11 wt-% or less, and containing an iron component of 0.06 wt-% or less of reduced ferric oxide, mercury and rare gas sealed in said glass bulb, a pair of discharge electrodes for causing discharge in said glass bulb, and a phosphor layer formed on an inner wall of said glass bulb having a blue series phosphor activated by dihydric europium or a blue series phosphor activated by dihydric europium and magnesium, wherein said lamp lights when a tube wall load is 0.07 W/cm² or less.

10. A fluorescent lamp according to claim 9, wherein said phosphor additionally has a green series phosphor and a red series phosphor and said blue series phosphor is formed between said glass bulb and said green series phosphor and said red series phosphor.

11. A fluorescent lamp having a glass bulb containing lead-free component practically, containing sodium oxide of 11 wt-% or less, and containing an iron component of 0.06 wt-% or less of reduced ferric oxide, mercury and rare gas sealed in said glass bulb, a pair of discharge electrodes for causing discharge in said glass bulb, a phosphor layer formed on an inner wall of said glass bulb, and a protective film which is formed between said glass bulb and said phosphor and has a function for suppressing reaction between said sodium component in said glass bulb and said mercury and also absorbing ultraviolet rays, wherein said lamp lights when a tube wall load is 0.07 W/cm² or less.

12. A fluorescent lamp according to claim 11, wherein a particle diameter of said metallic oxide is about 0.1 μm or less.

13. A fluorescent lamp according to claim 11, wherein a particle diameter of said metallic oxide is within a range from about 0.02 to 0.04 μm.

14. A fluorescent lamp according to claim 11, wherein a thickness of said protective film is within a range from about 0.1 to 1.0 μm.

15. A fluorescent lamp according to claim 11, wherein said protective film is structured in layers divided into a first metallic oxide film containing said first metallic oxide and a second metallic oxide film containing said second metallic oxide.

16. A fluorescent lamp according to claim 9 or 11, wherein an ultraviolet ray transmission factor at a wavelength of 300 nm at a thickness of said glass bulb of 0.8 mm is 35% or more.

17. A fluorescent lamp having a glass bulb containing lead-free component practically, containing sodium oxide of 11 wt-% or less, and having an ultraviolet ray transmission factor of 10% or more at a wavelength of 300 nm or less, mercury and rare gas sealed in said glass bulb, a pair of discharge electrodes for causing discharge in said glass bulb, and a phosphor layer with a thickness of 10 μm or more formed on an inner surface of said glass bulb.

18. A fluorescent lamp according to claim 17, wherein a film thickness of said phosphor layer is within a range from 15 to 60 μm.

19. A low-pressure mercury vapor discharge lamp according to claim 17, wherein a film thickness of said phosphor layer is within a range from 20 to 40 μm.

20. A fluorescent lamp according to claim 17, wherein said glass bulb has a bent part and a film thickness of a phosphor layer at said bent part is formed to be thinner than a film thickness in another area.

21. A self-ballasted fluorescent lamp having a low-pressure mercury vapor discharge lamp stated in claim 20 having a tube diameter of said glass bulb of 18 mm or less and a thickness of 0.5 to 1.5 mm, a cover for supporting said low-pressure mercury vapor discharge lamp, a screw base attached to said cover, and a lighting circuit electrically connected to said screw base and housed in said cover for lighting said low-pressure mercury vapor discharge lamp.

21. A self-ballasted fluorescent lamp according to claim 21, wherein said glass bulb contains SiO₂ of 60 to 75 wt-%, Al₂O₃ of 1 to 5 wt-%, Li₂O of 1 to 5 wt-%, Na₂O of 5 to 10 wt-%, K₂O of 1 to 10 wt-%, CaO of 0.5 to 5 wt-%, MgO of 0.5 to 5 wt-%, SrO of 0.5 to 10 wt-%, and BaO of 0.5 to 7 wt-% and has a composition of SrO/BaO≧1.5 and MgO+BaO≦SrO and amalgam for feeding mercury vapor is introduced in said glass bulb.
